(19) United States
(12) Patent Application Publication
(10) Pub. No.: US 2024/0381142 A1
(43) Pub. Date: Nov. 14, 2024

(54) QUALITY OF EXPERIENCE PRIORITY METHOD AND APPARATUS

(71) Applicant: ZTE Corporation, Shenzhen (CN)

(72) Inventors: Yansheng LIU, Shenzhen (CN); Yin GAO, Shenzhen (CN); Dapeng LI, Shenzhen (CN); Man ZHANG, Shenzhen (CN); Zhuang LIU, Shenzhen (CN)

(21) Appl. No.: 18/675,602

(22) Filed: May 28, 2024

Related U.S. Application Data
(63) Continuation of application No. PCT/CN2022/122250, filed on Sep. 28, 2022.

(51) Int. Cl. H04W 24/08

(52) U.S. Cl. CPC H04W 24/08

(57) ABSTRACT

This document is directed to methods, systems, and devices related to wireless communication. A method of wireless communication, comprising: receiving, by a first network node, from a core network (CN), a next generation application protocol (NGAP) message; wherein the NGAP message includes a quality of experience (QoE) configuration list; wherein the QoE configuration list includes a QoE identification (ID) and QoE priority information; wherein the CN predefines the QoE priority information; and processing, by the first network node, the QoE configuration list.

### CROSS REFERENCE TO RELATED APPLICATIONS

This patent document is a continuation of and claims benefit of priority to International Patent Application No. PCT/CN2022/122250, filed on Sep. 28, 2022. The entire content of the before-mentioned patent application is incorporated by reference as part of the disclosure of this application.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), 4th Generation (4G), and long-term evolution (LTE) communication systems with respect to introducing quality of experience priority mechanism.

In one example aspect, a wireless communication method is disclosed. The method includes receiving, by a first network node, from a core network (CN), a next generation application protocol (NGAP) message; wherein the NGAP message includes a quality of experience (QoE) configuration list; wherein the QoE configuration list includes a QoE identification (ID) and QoE priority information; wherein the CN predefines the QoE priority information; and processing, by the first network node, the QoE configuration list.

In another example aspect, another wireless communication method is disclosed. The method includes receiving, by a first network node, from a core network (CN), a next generation application protocol (NGAP) message; wherein the NGAP message includes a quality of experience (QoE) configuration list; determining, by the first network node, QoE priority rule based on the QoE configuration list; and transmitting, from the first network node, to the wireless communication device, the QoE configuration list containing the QoE priority rule through a radio resource control (RRC) message.

In another example aspect, another wireless communication method is disclosed. The method includes receiving, by a first network node, from an administration, and maintenance (OAM), a quality of experience (QoE) configuration list; wherein the QoE configuration list contains QoE identification (ID) and QoE priority information; wherein the OAM predefines the QoE priority information; and processing, by the first network node, the QoE configuration list.

In another example aspect, another wireless communication method is disclosed. The method includes receiving, by a first network node, from a core network (CN) or an administration, and maintenance (OAM), a next generation application protocol (NGAP) message; wherein the NGAP message contains user equipment (UE) identification (ID) and QoE priority rule information; wherein the QoE priority rule information contains at least one of the following: range availability, QoE reporting activity, buffered QoE reporting, QoE reporting duration, QoE reporting priority, or dual connection leg switching; and configuring, by the first network node, to operate according to the QoE priority rule information.

In another example aspect, another wireless communication method is disclosed. The method includes receiving, by a first network node, from a core network (CN) or an administration, and maintenance (OAM), a next generation application protocol (NGAP) message; wherein the NGAP message includes contains user equipment (UE) identification (ID) and a quality of experience (QoE) configuration list; determining, by the first network node, QoE priority rule based on the QoE configuration list; and transmitting, from the first network node, to the wireless communication device, the QoE configuration list containing the UE ID and the QoE priority rule through a radio resource control (RRC) message.

In another example aspect, another wireless communication method is disclosed. The method includes receiving, by a target network node, from a source network node, an Xn Application Protocol (XnAP) message; wherein the XnAP message contains user equipment (UE) identification (ID) and quality of experience (QoE) information; wherein the QoE information further contains QoE ID and QoE priority information; and processing, by the target network node, the XnAP message.

In another example aspect, another wireless communication method is disclosed. The method includes receiving, by a core network (CN), from a source network node through a target network node, a first next generation application protocol (NGAP) message; wherein the first NGAP message is a handover message; wherein the first NGAP message contains user equipment (UE) identification (ID) and quality of experience (QoE) information; wherein the QoE information further contains QoE ID and QoE priority information; transmitting, by the CN, to the target network node, a second next generation application protocol (NGAP) message indicating hangover request; wherein the second NGAP message contains the user equipment (UE) identification (ID) and quality of experience (QoE) information; and wherein the QoE information further contains QoE ID and QoE priority information.

In another example aspect, another wireless communication method is disclosed. The method includes transmitting, to a first network node, by a core network (CN), a next generation application protocol (NGAP) message; wherein the NGAP message includes a quality of experience (QoE) configuration list; wherein the QoE configuration list includes a QoE identification (ID) and QoE priority information; wherein the CN predefines the QoE priority information; and processing, by the first network node, the QoE configuration list.

In another example aspect, another wireless communication method is disclosed. The method includes transmitting, to a first network node, by a core network (CN), a next generation application protocol (NGAP) message; wherein the NGAP message includes a quality of experience (QoE) configuration list; determining, by the first network node, QoE priority rule based on the QoE configuration list; and receiving, from the first network node, by the wireless communication device, the QoE configuration list containing the QoE priority rule through a radio resource control (RRC) message.

In another example aspect, another wireless communication method is disclosed. The method includes transmitting, to a first network node, by an administration, and maintenance (OAM), a quality of experience (QoE) configuration list; wherein the QoE configuration list contains QoE identification (ID) and QoE priority information; wherein the OAM predefines the QoE priority information; and processing, by the first network node, the QoE configuration list.

In another example aspect, another wireless communication method is disclosed. The method includes transmitting, to a first network node, by a core network (CN) or an administration, and maintenance (OAM), a next generation application protocol (NGAP) message; wherein the NGAP message contains user equipment (UE) identification (ID) and QoE priority rule information; wherein the QoE priority rule information contains at least one of the following: range availability, QoE reporting activity, buffered QoE reporting, QoE reporting duration, QoE reporting priority, or dual connection leg switching; and configuring, by the first network node, to operate according to the QoE priority rule information.

In another example aspect, another wireless communication method is disclosed. The method includes transmitting, to a first network node, by a core network (CN) or an administration, and maintenance (OAM), a next generation application protocol (NGAP) message; wherein the NGAP message includes contains user equipment (UE) identification (ID) and a quality of experience (QoE) configuration list; determining, by the first network node, QoE priority rule based on the QoE configuration list; and receiving, from the first network node, by the wireless communication device, the QoE configuration list containing the UE ID and the QoE priority rule through a radio resource control (RRC) message.

In another example aspect, another wireless communication method is disclosed. The method includes transmitting, to a target network node, by a source network node, an Xn Application Protocol (XnAP) message; wherein the XnAP message contains user equipment (UE) identification (ID) and quality of experience (QoE) information; wherein the QoE information further contains QoE ID and QoE priority information; and processing, by the target network node, the XnAP message.

In another example aspect, another wireless communication method is disclosed. The method includes transmitting, to a core network (CN), by a source network node through a target network node, a first next generation application protocol (NGAP) message; wherein the first NGAP message is a handover message; wherein the first NGAP message contains user equipment (UE) identification (ID) and quality of experience (QoE) information; wherein the QoE information further contains QoE ID and QoE priority information; receiving, from the CN, by the target network node, a second next generation application protocol (NGAP) message indicating hangover request; wherein the second NGAP message contains the user equipment (UE) identification (ID) and quality of experience (QoE) information; and wherein the QoE information further contains QoE ID and QoE priority information.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the method.

The above and other aspects and their implementations are described in greater detail in the drawings, the descriptions, and the claims.

### BRIEF DESCRIPTION OF THE DRAWINGS

FIG. 1 illustrates an administration, and maintenance (OAM) or a core network (CN) that configures QoE priority.

FIG. 2 illustrates an example of configuration of QoE priority at RAN node.

FIG. 3 illustrates an example of configuration of QoE priority at RAN node

FIG. 4 illustrates an example of configuration of QoE priority at UE.

FIG. 5 illustrates an example of process of OAM or CN handles different QoE priority configurations.

FIG. 6 illustrates an example of process of OAM or CN handles different QoE priority configurations.

FIG. 7 illustrates an example of process of RAN node handles different QoE priority configurations.

FIG. 8 illustrates an example of QoE priority retrieval from source RAN node.

FIG. 9 illustrates an example of transferring QoE priority information during Xn based handover.

FIG. 10 illustrates an example of transferring QoE priority information during NG based handover.

FIG. 11 is a flowchart illustrating an example method.

FIG. 12 is a flowchart illustrating an example method.

FIG. 13 is a flowchart illustrating an example method.

FIG. 14 is a flowchart illustrating an example method.

FIG. 15 is a flowchart illustrating an example method.

FIG. 16 is a flowchart illustrating an example method.

FIG. 17 is a flowchart illustrating an example method.

FIG. 18 is a flowchart illustrating an example method.

FIG. 19 is a flowchart illustrating an example method.

FIG. 20 is a flowchart illustrating an example method.

FIG. 21 is a flowchart illustrating an example method.

FIG. 22 is a flowchart illustrating an example method.

FIG. 23 is a flowchart illustrating an example method.

FIG. 24 is a flowchart illustrating an example method.

FIG. 25 is a block diagram example of a wireless communication system.

FIG. 26 is a flowchart of an example method of wireless communication.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

Currently, quality of experience (QoE) does not explicitly define priority. The general consensus now is that for a same user equipment (UE), the signaling based QoE is more important than the management based QoE. However, the granularity of the importance between different QoE configurations/sessions (e.g., between signaling based QoE configuration and management based QoE configuration, between different signaling based QoE configurations, or between different management QoE configurations) has never been defined. When certain QoE sessions need to be released under certain conditions (e.g., resource limitation), the release method of part of QoE sessions is relied on NW/UE implementation. By introducing the priority in QoE mechanism, system can follow specific rule to recognize certain QoE is more important than the others, and specific treatments can be used for QoE sessions with different priority level.

QoE feature is used by network to collect user experience from single UE or multiple UEs. New radio (NR) QoE is introduced in Rel-17. Currently, priority has not been defined for QoE. All management based QoE configuration/sessions share the same priority. All signaling based QoE configurations/sessions share the same priority. When network needs to release certain configured QoE configurations or run certain QoE sessions, without different priority levels, it can only rely on implementation.

### Embodiment 1

The QoE priority is used to divide QoE configurations/missions/sessions into different levels. Different QoE priority (QoE configurations/missions/sessions with different levels) may be treated differently in some scenarios.

When radio access network (RAN) overload occurs, the QoE session may not be impacted for the paused reporting command if its QoE priority is higher than the threshold.

When RAN overload occurs, RAN visible QoE session may not be impacted for the paused reporting command if its QoE priority is higher than the threshold.

For buffered QoE reports (in either RRC_CONNECTED, RRC_INACTIVE, or RRC_IDLE state), the QoE reports with lower priority level may be overwritten/deleted first when the buffer is full.

When UE uploads buffered QoE reports, QoE reports with higher priority level may be uploaded first.

When UE local resource is limited, performance of QoE session with higher priority may be guaranteed and lower priority QoE session measurements may be paused/released to save the resource.

Note that the scenarios discussed above are examples. The functionality for QoE priority is not limited into the discussions above.

The following alternatives may be used for QoE priority definitions:

Limited level numbers (e.g., level 0, level 1, level 2, . . . , level N . . . ). Each level number stands for a type of QoE priority. Each QoE mission/session may be configured a level number.

[Low, medium, high] or [low, high]. Instead of using level numbers, the QoE priority level may be represented by the string (e.g., char “low”) or bit string (e.g., 001==low, 010==medium, 100==high) directly.

[Low, medium, high] or [low, high]. Also, the QoE priority level can also be marked by using enumerated IE directly. The QoE priority may be configured with the other part of QoE configuration in initial QoE configuration. Or it can also be configured/modified in later procedures (e.g., QoE modification procedure). See detailed discussion in the following embodiments.

1 bit indicator. In this alternative, there are two levels of the QoE priority. QoE session/configuration with 1 bit indicator has higher QoE priority than QoE session/configuration without 1 bit indicator, or vice versa that QoE session/configuration with 1 bit indicator has lower QoE priority than QoE session/configuration without 1 bit indicator.

This alternative of using 1 bit indicator is to distinguish different QoE levels.

The tabular of above alternatives is shown below:

### Limited Level Numbers

| | | | | |
|---|---|---|---|---|
| IE/Group | Pres- | | IE type and | |
| Name | ence | Range | reference | Semantics description |

| | | | |
|---|---|---|---|
| QoE | O | INTEGER | This IE is present when |
| Priority | | (0 . . . | message containing the QoE |
| | | N, . . .) | priority level information. |
| | | | The IE indicates the priority |
| | | | level of the application layer |
| | | | measurement configuration. |

### Bit String

| | | | | |
|---|---|---|---|---|
| IE/Group | Pres- | | IE type and | |
| Name | ence | Range | reference | Semantics description |

| | | | |
|---|---|---|---|
| QoE | O | BIT | This IE is present when |
| Priority | | STRING | message containing the QoE |
| | | (M . . . | priority level information. |
| | | N, . . .) | The IE indicates the priority |
| | | | level of the application layer |
| | | | measurement configuration. |

### Enumerated Priority Level Info

| | | | | |
|---|---|---|---|---|
| IE/Group | | | IE type and | |
| Name | Presence | Range | reference | Semantics description |

| | | | |
|---|---|---|---|
| QoE Priority | O | ENUMERATED | This IE is present when |
| | | (Low, Medium, | message containing the QoE |
| | | High), or | priority level information. The |
| | | ENUMERATED | IE indicates the priority level |
| | | (Low, High) | of the application layer |
| | | | measurement configuration. |

### 1 Bit Indicator

| | | | | |
|---|---|---|---|---|
| IE/Group | | | IE type and | |
| Name | Presence | Range | reference | Semantics description |

| | | | |
|---|---|---|---|
| High QoE | O | ENUMERATED | This IE is present when |
| Priority | | (true, . . .), or | message containing the QoE |
| | | ENUMERATED | priority level information. The |
| | | (high priority, . . .), | IE indicates the priority level |
| | | or | of the application layer |
| | | ENUMERATED | measurement configuration. |
| | | (high, . . .) | |
| Low QoE | O | ENUMERATED | This IE is present when |
| Priority | | (true, . . .), or | message containing the QoE |
| | | ENUMERATED | priority level information. The |
| | | (low priority, . . .), | IE indicates the priority level |
| | | or | of the application layer |
| | | ENUMERATED | measurement configuration. |
| | | (low, . . .) | |

### Embodiment 2

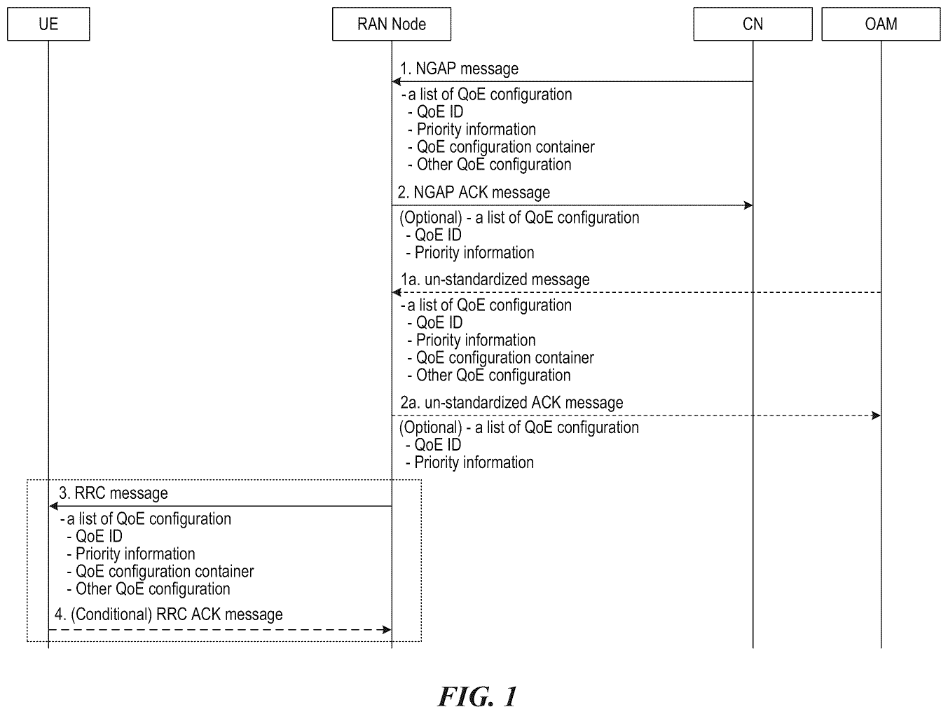

FIG. 1 shows an example of an administration, and maintenance (OAM) or a core network (CN) that configures the QoE priority.

In this embodiment, either CN or OAM can decide QoE priority and configure QoE priority information for each QoE configuration to RAN node. Both signaling based QoE and management based QoE can be configured a QoE priority information. Two alternatives when RAN node receives the QoE configuration with the QoE priority information.

Alternative 1: When RAN node receives the QoE information, it transfers the QoE configuration and its priority information to the UE accordingly. The QoE priority information in this embodiment is only defined/determined by the CN or OAM.

Alternative 2: When RAN node receives the QoE information, it will use the received QoE priority information as a reference. The final QoE priority for this QoE configuration is defined by RAN node based on the received QoE priority information from CN/OAM and RAN node and UE condition. In other words, the QoE priority information received at UE may not be the same information received at RAN node. RAN node may add final QoE priority information into ACK message and send back to the CN or OAM. This is shown in FIG. 1 steps 2 and 2a. (Note: The final decision is made by RAN node.)

The procedure used between CN and RAN node (e.g., a next generation application protocol (NGAP) procedure) may be used for initial QoE configuration or QoE priority modification for the existing QoE configuration.

The radio resource control (RRC) procedure is optional, such that, RAN node may not send the priority information to the UE.

The procedure used between RAN node and UE (e.g., RRC procedure) may be used for initial QoE configuration or QoE priority modification for the existing QoE configuration. As shown in FIG. 1 step 3, RRC message does not need reply message, therefore, step 4 is an optional message.

The related messages (e.g., NGAP message, RRC message) may be contained at least one of the following information:
QoE configuration list;
QoE ID (this is used to mark a QoE configuration. Different QoE configurations have different IDs. For the same QoE configuration, same or different ID may be used in RRC procedure and NGAP procedure);
QoE priority information (this is used to mark the priority level of a QoE configuration);
QoE configuration container (this contains the QoE configuration. It is transparent to the RAN side); and
Other QoE configurations (e.g., area scope information, RAN visible QoE information, and so on).

Tabular may be used in step1 is shown below:

| IE/Group | | | IE type and | |
|---|---|---|---|---|
| Name | Presence | Range | reference | Semantics description |
| QoE ID | M | | OCTET STRING | This is the unique ID for each |
| | | | (SIZE (X)) | QoE configuration and is used |
| | | | | to mark different QoE |
| | | | | configurations. |
| QoE priority | # check the tabular in embodiment 1. | | | |
| Container for | O | | OCTET STRING | Contains application layer |
| Application | | | (SIZE (1 . . . 8000)) | measurement configuration, |
| Layer | | | | see Annex L in 26.247 [46], |
| Measurement | | | | clause 16.5 in TS 26.114 [51] |
| Configuration | | | | and clause 9 in TS 26.118 |
| | | | | [52]. Present in case of initial |
| | | | | QoE configuration and shall |
| | | | | be included in Source to |
| | | | | Target Transparent Container |
| | | | | IE for signaling-based QMC |
| | | | | during NG-based handover. |

### Embodiment 3

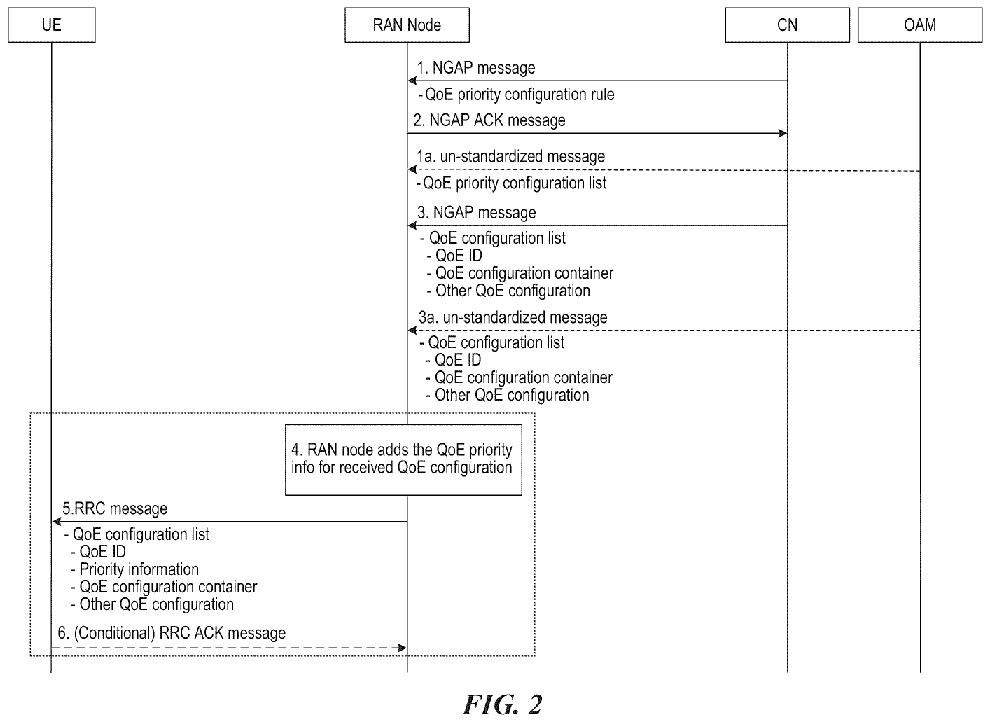

FIG. 2 shows an example of configuration of QoE priority at RAN node that relates to a non-UE associated procedure.

In this embodiment, CN or OAM does not configure QoE priority information for each QoE configurations. Instead, CN or OAM configures RAN node based on a type of rules identifying how to configure different QoE priorities for the received QoE configurations via a NGAP (CN) non-UE associated procedure or via a no standardized procedure (OAM). Hence, the CN or OAM only configures the common QoE configuration to RAN node. When RAN node receives QoE configurations, it will configure the priority information based on the received QoE priority rule for each received QoE configurations. Both signaling based QoE and management based QoE can be configured as QoE priority information.

QoE priority rule may be priority range of each QoE service types. The limitation may contain upper bound and/or lower bound of QoE priority. It may also be the value range of the QoE priority.

A NGAP procedure between CN and RAN node may be used for CN to forward QoE priority rule to RAN node.

At least one of the following information shall be contained in the message:
RAN node ID;
QoE priority rule; and
For each QoE service types, its upper bound and/or lower bound of the priority level (it is possible to have either or both limitation of the QoE priority). QoE configuration/session with this service type can be configured as a high priority QoE configuration/session.

The RRC procedure is optional, such that, RAN node may not send the priority information to the UE.

When RAN node receives QoE priority rule, for each received QoE configuration, it adds QoE priority information based on the received QoE priority rule. RRC reply message may not be necessary in some cases.

A RRC procedure may be used for RAN node to forward RAN node received QoE configuration and a new defined QoE priority information to the UE. This message may be used for the initial QoE priority configuration for newly arrived QoE or QoE priority modification for the existing QoE configuration. At least one of the following information shall be contained in the message:
QoE configuration list (a list which may contain at least one QoE configuration);
QoE ID (this is used to mark a QoE configuration. Different QoE configurations have different IDs. The ID used in NGAP message may be different with the one used in RRC message);
For each QoE service types, its upper bound and/or lower bound of the priority level (it is possible to have either or both limitation of the QoE priority.). QoE configuration/session with this service type can be configured as a high/low priority QoE configuration/session;
QoE configuration container (this contains the QoE configuration. It is transparent to the RAN side); and
Other QoE configurations (e.g., area scope information, RAN visible QoE information, and so on).

The RRC ACK message may not always necessary in this procedure (e.g., for RRCReconfiguration procedure, the reply message is needed. For RRCRelease procedure, the reply message is not necessary).

| IE/Group | | | IE type and |
|---|---|---|---|
| Name | Presence | Range | reference |
| RAN ID | M | | 9.3.3.2 |
| QoE priority | | 1 . . . <maxnonofQoEServiceTypes> | |
| configuration list | | | |
| >QoE priority rule | O | | Section XXX |

Examples of Embodiment 3 Tabular as shown:

| | | | | |
|---|---|---|---|---|
| IE/Group | | | | Semantics |
| Name | Presence | Range | IE type and reference | description |

| | | | |
|---|---|---|---|
| Service Type | M | ENUMERATED | This IE indicates the |
| | | (QMC for DASH | service type of QoE |
| | | streaming, QMC for | measurements. |
| | | MTSI, QMC for VR, . . .) | |
| QoE priority | O | INTEGER (M . . . N, . . .), | The QoE priority of |
| upper bound | | or BIT STRING (M . . . | this service type |
| | | N . . .), or ENUMERATED | should not higher than |
| | | (Low, Medium, High) | this upper bound. |
| QoE priority | O | INTEGER (M . . . N, . . .), or | The QoE priority of |
| lower bound | | BIT STRING(M . . . N . . .), | this service type |
| | | or ENUMERATED (Low, | should not lower than |
| | | Medium, High) | this upper bound. |

| | | | | |
|---|---|---|---|---|
| IE/Group | | | | Semantics |
| Name | Presence | Range | IE type and reference | description |

| | | | |
|---|---|---|---|
| Service Type | M | ENUMERATED | This IE indicates the |
| | | (QMC for DASH | service type of QoE |
| | | streaming, QMC for | measurements. |
| | | MTSI, QMC for VR, . . .) | |
| QoE priority | O | BIT STRING (M . . . | The right bit is the |
| value range | | N . . .) | most important bit in |
| | | | this bit string. The |
| | | | number of bits |
| | | | presents the allowed |
| | | | priority level. Bit with |
| | | | value (e.g., “1”) |
| | | | presents the allowed |
| | | | priority level of this |
| | | | service type. |

| | | | | |
|---|---|---|---|---|
| IE/Group | | | | Semantics |
| Name | Presence | Range | IE type and reference | description |

| | | | |
|---|---|---|---|
| Service Type | M | ENUMERATED | This IE indicates the |
| | | (QMC for DASH | service type of QoE |
| | | streaming, QMC for | measurements. |
| | | MTSI, QMC for VR, . . .) | |
| QoE priority | O | OCTET STRING | The first four bits |
| value range | | | present the max |
| | | | priority of this service |
| | | | type. The last four bits |
| | | | present the min |
| | | | priority of this service |
| | | | type. |

| | | | | |
|---|---|---|---|---|
| IE/Group | | | | Semantics |
| Name | Presence | Range | IE type and reference | description |

| | | | |
|---|---|---|---|
| Service Type | M | ENUMERATED | This IE indicates the |
| | | (QMC for DASH | service type of QoE |
| | | streaming, QMC for | measurements. |
| | | MTSI, QMC for VR, . . .) | |
| QoE priority | O | ENUMERATED | This indicator presents |
| availability | | (true . . .) | whether the QoE |
| | | | configuration of this |
| | | | service type can be |
| | | | configured with higher |
| | | | priority indicator. |

| | | | | |
|---|---|---|---|---|
| IE/Group | | | | Semantics |
| Name | Presence | Range | IE type and reference | description |

| | | | |
|---|---|---|---|
| Service Type | M | ENUMERATED | This IE indicates the |
| | | (QMC for DASH | service type of QoE |
| | | streaming, QMC for | measurements. |
| | | MTSI, QMC for VR, . . .) | |
| QoE priority | O | ENUMERATED | This indicator presents |
| availability | | (true . . .) | whether the QoE |
| | | | configuration of this |
| | | | service type can be |
| | | | configured with lower |
| | | | priority indicator. |

### Embodiment 4

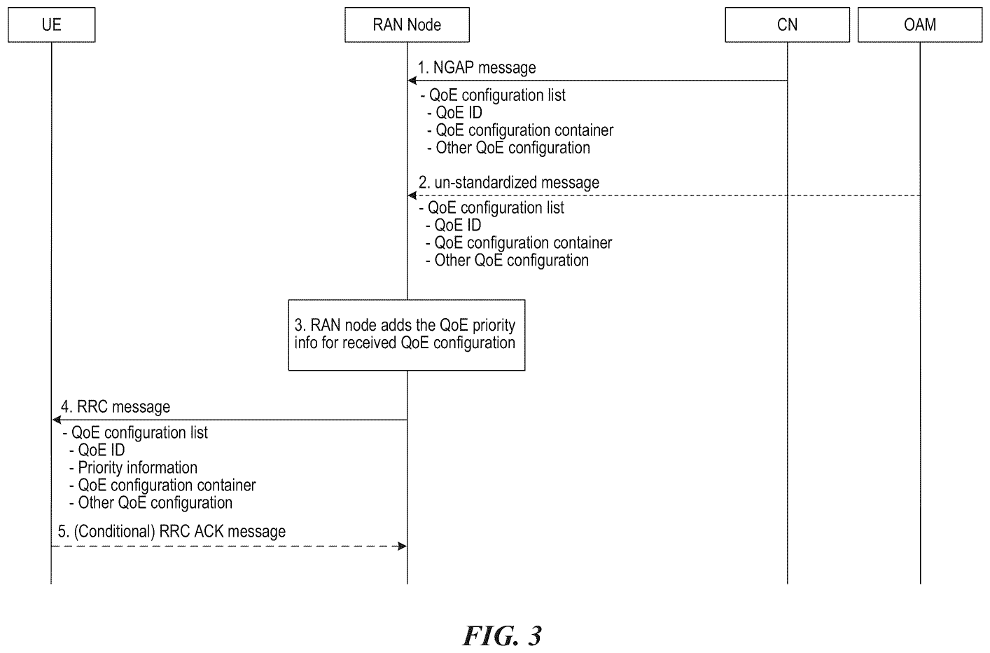

FIG. 3 shows an example of configuration of QoE priority at RAN node and that the RAN node decides the final QoE priority.

In this embodiment, RAN node is the only entity that is responsible for the QoE priority configuration. Configuration of QoE priority for each received QoE configurations is based on RAN node implementation. RAN node receives the common QoE configuration (QoE configuration without priority info) from either CN or OAM. Then RAN node adds the QoE priority information for each received QoE configurations and forwards the modified configurations to UE. Both signaling based QoE and management based QoE can be configured a QoE priority information.

A RRC procedure may be used for RAN node to forward RAN node received QoE configuration and the newly defined QoE priority information to UE. This message may be used for the initial QoE priority configuration for newly arrived QoE or QoE priority modification for the existing QoE configuration.

At least one of the following information shall be contained in the message:
QoE configuration list (a list which may contain at least one QoE configuration);
QoE ID (this is used to mark a QoE configuration. Different QoE configurations have different IDs. The ID used in NGAP message may be different with the one used in RRC message);
QoE priority information (this is generated by RAN node and is used to mark the priority level of a QoE configuration);
QoE configuration container (this contains the QoE configuration. It is transparent to the RAN side); and
Other QoE configurations (e.g., area scope information, RAN visible QoE information, and so on).

The RRC ACK message may not always necessary in this procedure (e.g., for RRCReconfiguration procedure, the reply message is needed. For RRCRelease procedure, the reply message is not necessary).

### Embodiment 5

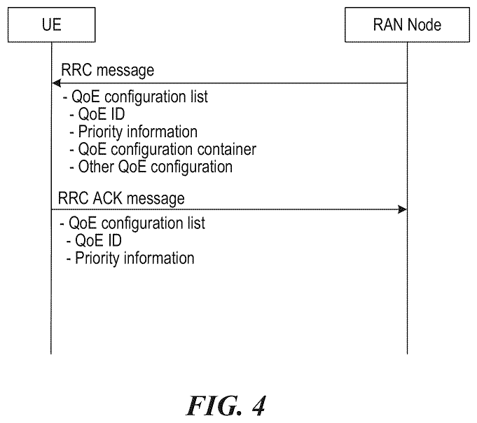

FIG. 4 shows an example of configuration of QoE priority at UE and that the UE decides the final QoE priority.

In this embodiment, UE is the entity responsible for the QoE priority. Both signaling based QoE and management based QoE can be configured based on QoE priority information. RAN node may configure the QoE priority information to the UE as reference, but the final decision on the QoE priority for the received QoE configuration is made by the UE itself. If UE is not going to use the received QoE priority for a QoE configuration, UE may add the final QoE priority information into the RRC ACK message accordingly.

RAN node sends the UE a RRC message. At least one of the following information shall be added into this message:
QoE configuration list (a list which may contain at least one QoE configuration);
QoE ID (this is used to mark a QoE configuration. Different QoE configurations have different IDs. The ID used in NGAP message may be different with the one used in RRC message);
Reference information on QoE priority (this is generated by RAN node and is used to mark the reference priority level of a QoE configuration);
QoE configuration container (this contains the QoE configuration. It is transparent to the RAN side); and
Other QoE configurations (e.g., area scope information, RAN visible QoE information, and so on).

UE replies RAN node a RRC ACK message. At least one of the following information into this message:
QoE configuration list (a list which may contain at least one QoE configuration);
QoE ID (this is used to mark a QoE configuration. Different QoE configurations have different IDs. The QoE configuration ID will be added here if UE does not want to use the received QoE priority for this QoE config); and
QoE priority information (this is generated by UE and is used to mark the final decided priority level of the QoE configuration).

### Embodiment 6

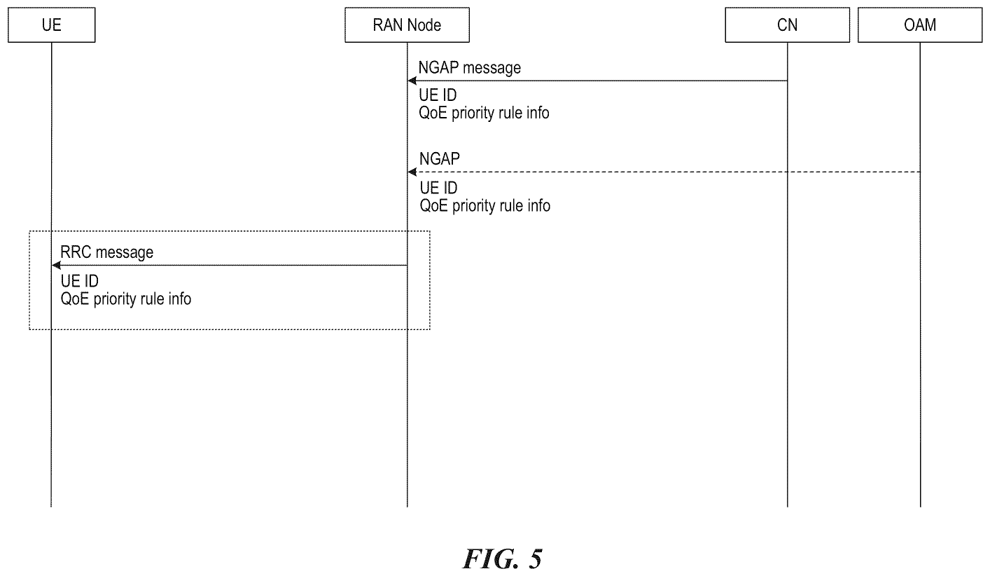

FIG. 5 shows an example of process of OAM or CN handles different QoE priority configurations. This is UE associated procedure.

In this embodiment, CN or OAM configures how to treat QoE session with different priorities in certain case for each UE by using UE associated procedures. More specifically, CN or OAM will send the rules about the different QoE priorities to a UE. Then the CN or OAM may not need to add extra information on how to handle the different QoE priorities when the QoE-related command is transferred to UE (e.g., pause/resume QoE reporting, how to handle the QoE reports when UE is in either RRC_INACTIVE or RRC_IDLE, and so on). The priority rule information may be suited for both signaling based QoE and management based QoE or either signaling based QoE or management QoE.

CN sends NGAP message to RAN node. The message may contain the QoE priority information. At least one of the following information may be added into this message:
UE ID;
The available range (e.g., only for signaling based QoE, only for management based QoE, for both signaling based QoE and management based QoE);

### Pause/Resume QoE Reporting (Either Alternative May be Possible):

QoE reporting will not be impacted if its QoE priority level is [higher/equal or higher] than X or the QoE session has the high priority indicator; and
QoE reporting will be impacted if its QoE priority level is [lower/equal or lower] than X or the QoE session has the low priority indicator.

### Buffered QoE Report:

QoE priority level sequence on how to arrange the buffered QoE reports overwrite rules.

QoE reports cannot be overwritten if its QoE priority level is [higher/equal or higher] than X or the QoE session has the higher priority indicator.

QoE reports can be overwritten if its QoE priority level is [lower/equal or lower] than X or the QoE session has the lower priority indicator.

QoE reports shall be kept for a longer time when UE is in either RRC_INACTIVE or RRC_IDLE state.

QoE reports can be kept at UE side longer if its QoE priority level is [higher/equal or higher] than X or the QoE session has the higher priority indicator or the QoE session does not have the lower priority indicator.

### QoE Reporting Priority:

QoE priority level sequence on how to arrange the buffered QoE reports reporting rules (e.g. QoE report with higher priority shall be reported to NW first).

QoE reporting may trigger RRC state switching if this QoE session's priority is [higher/equal or higher] than X or the QoE session has the higher priority indicator.

QoE reporting cannot trigger RRC state switching if this QoE session's priority is [lower/equal or lower] than X or the QoE session has the lower priority indicator.

### DC (Dual Connection) Leg Switching:

In DC case, UE connects two RAN nodes (e.g., Main Node and Secondary Node). For an ongoing QoE reporting between UE and one node (either MN or SN), if the QoE session's priority is [higher/equal or higher] than X or the QoE session has the higher priority indicator, the UE can stop the current QoE reporting via current node and continue to report the QoE data via the other node.

For an ongoing QoE reporting between UE and one node (either MN or SN), if the QoE session's priority is [lower/equal or lower] than X or the QoE session has the lower priority indicator, the UE cannot stop the current QoE reporting via current node and continue to report the QoE data via the other node.

Note: The RRC procedure is optional, such that RAN node may not send the priority information to the UE.

When RAN node receives the QoE priority rule information, it will forward this information to UE. At least one of the following information may be added into this message:
UE ID;
The available range (e.g., only for signaling based QoE, only for management based QoE, for both signaling based QoE and management based QoE).

### Pause/Resume QoE Reporting (Either Alternative May be Possible.)

The QoE reporting will not be impacted if its QoE priority level is [higher/equal or higher] than X or the QoE session has the high priority indicator.

The QoE reporting will be impacted if its QoE priority level is [lower/equal or lower] than X or the QoE session has the low priority indicator.

### Buffered QoE Report (Either Alternative May be Possible.):

The QoE priority level sequence on how to arrange the buffered QoE reports overwrite rules.

The QoE reports cannot be overwritten if its QoE priority level is [higher/equal or higher] than X or the QoE session has the higher priority indicator.

The QoE reports can be overwritten if its QoE priority level is [lower/equal or lower] than X or the QoE session has the lower priority indicator.

QoE reports shall be kept for a longer time when UE is in either RRC_INACTIVE or RRC_IDLE state.

The QoE reports can be kept at UE side longer if its QoE priority level is [higher/equal or higher] than X or the QoE session has the higher priority indicator or the QoE session does not have the lower priority indicator.

### QoE Reporting Priority

The QoE priority level sequence on how to arrange the buffered QoE reports reporting rules (e.g., QoE report with higher priority shall be reported to NW first).

The QoE reporting may trigger the RRC state switching if this QoE session's priority is [higher/equal or higher] than X or the QoE session has the higher priority indicator.

The QoE reporting cannot trigger the RRC state switching if this QoE session's priority is [lower/equal or lower] than X or the QoE session has the lower priority indicator.

### DC (Dual Connection) Leg Switching:

In DC case, UE connects two RAN nodes (e.g., Main Node and Secondary Node). For an ongoing QoE reporting between UE and one node (either MN or SN), if QoE session's priority is [higher/equal or higher] than X or QoE session has the higher priority indicator, UE can stop the current QoE reporting via current node and continue to report QoE data via the other node.

For an ongoing QoE reporting between UE and one node (either MN or SN), if QoE session's priority is [lower/equal or lower] than X or QoE session has the lower priority indicator, the UE cannot stop the current QoE reporting via current node and continue to report the QoE data via the other node.

### Potential Tabular for NGAP Procedure:

| | | | | |
|---|---|---|---|---|
| IE/Group | | | | |
| Name | Presence | Range | IE type and reference | Semantics description |

| | | | |
|---|---|---|---|
| UE ID | M | 9.3.1.1 | |
| Available | M | ENUMERATED | Both means these rules |
| range of these | | (both, s-based, | work for both signaling |
| rules | | m-based . . .) | based QoE and |
| | | | management based QoE. |
| | | | S-based means these rules |
| | | | work for signaling based |
| | | | QoE only. |
| | | | M-based means these |
| | | | rules work for |
| | | | management based QoE |
| | | | only. |
| Priority for | O | INTEGER (M . . . | The QoE reporting will |
| pause/resume | | N, . . .), or BIT | not be impacted if its |
| QoE | | STRING (M . . . N . . .), or | QoE priority level is |
| reporting | | ENUMERATED | [higher/equal or higher] |
| | | (Low, Medium, High), | than this value or the QoE |
| | | or ENUMERATED | session has the priority |
| | | (true, . . .), or | indicator. OR The QoE |
| | | ENUMERATED (high | reporting will be |
| | | priority, . . .), or | impacted if its QoE |
| | | ENUMERATED | priority level is |
| | | (high, . . .) | [lower/equal or lower] |
| | | | than this value. |
| Priority for | O | INTEGER (M . . . | The QoE reports cannot |
| buffered QoE | | N, . . .), or BIT | be overwritten if its QoE |
| report | | STRING (M . . . N . . .), or | priority level is |
| | | ENUMERATED | [higher/equal or higher] |
| | | (Low, Medium, High), | than this value or the QoE |
| | | or ENUMERATED | session has the priority |
| | | (true, . . .), or | indicator. |
| | | ENUMERATED (high | The QoE reports can be |
| | | priority, . . .), or | overwritten if its QoE |
| | | ENUMERATED | priority level is |
| | | (high, . . .) | [lower/equal or lower] |
| | | | than this value. |
| Priority for | O | INTEGER (M . . . | The QoE reports can be |
| buffered | | N, . . .), or BIT | kept at UE side longer if |
| duration | | STRING (M . . . N . . .), | its QoE priority level is |
| | | or ENUMERATED | [higher/equal or higher] |
| | | (Low, Medium, High), | than this value or the QoE |
| | | or ENUMERATED | session has the priority |
| | | (true, . . .), or | indicator. |
| | | ENUMERATED (high | |
| | | priority, . . .), or | |
| | | ENUMERATED | |
| | | (high, . . .) | |
| Priority for | O | INTEGER (M . . . | The QoE reports shall be |
| QoE | | N . . .), or BIT STRING | reported prior if this QoE |
| reporting | | (M . . . N . . .), or | priority is [higher/equal |
| | | ENUMERATED | or higher] than this value |
| | | (Low, Medium, High), | or the QoE session has |
| | | or ENUMERATED | the priority indicator. |
| | | (true, . . .), or | |
| | | ENUMERATED (high | |
| | | priority, . . .), or | |
| | | ENUMERATED | |
| | | (high, . . .) | |
| DC leg | O | INTEGER (M . . . | The QoE reporting leg |
| switching | | N, . . .), or BIT | can be switch to another |
| | | STRING (M . . . N . . .), or | node if the QoE session's |
| | | ENUMERATED | priority is [higher/equal |
| | | (Low, Medium, High), | or higher] than this value |
| | | or ENUMERATED | or the QoE session has |
| | | (true, . . .), or | the priority indicator. |
| | | ENUMERATED (high | |
| | | priority, . . .), or | |
| | | ENUMERATED | |
| | | (high, . . .) | |

### Embodiment 7

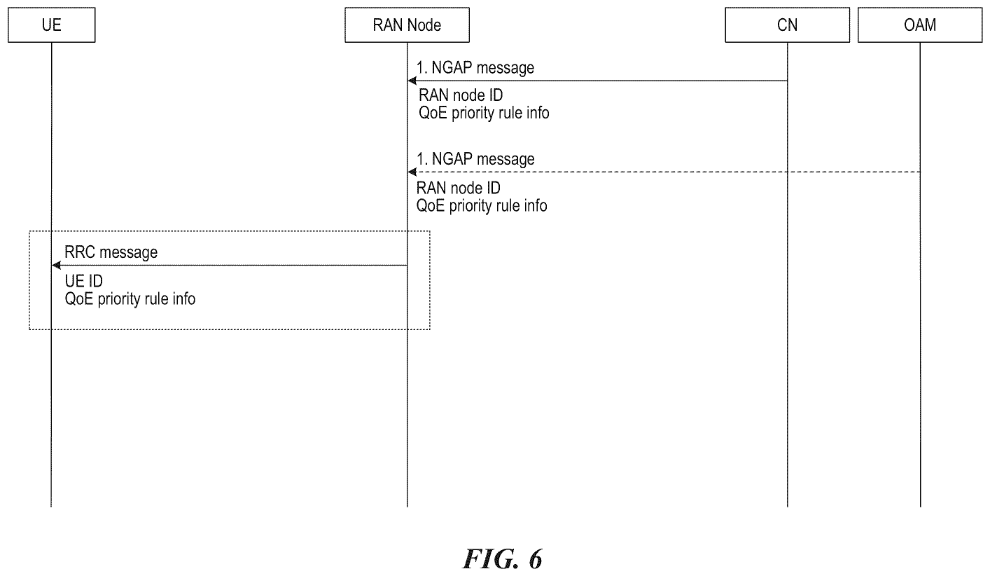

FIG. 6 shows an example of process of OAM or CN handles different QoE priority configurations. This is non-UE associated procedure.

In this embodiment, CN or OAM handles different QoE priority configurations with different priorities to RAN node by using non-UE associated procedure. When RAN node receives the message, it may configure this rule to certain UE (e.g., UE with configured QoE session or UE will be configured a QoE session). The priority rule information may be suited for both signaling based QoE and management based QoE or either signaling based QoE or management QoE.

RAN node may send all QoE priority configuration to UE by using RRC message without any QoE-related commands (e.g., pause/resume QoE reporting, how to handle the QoE reports when UE is in either RRC_INACTIVE or RRC_IDLE, and so on.).

RAN node may send the related QoE priority configuration to the UE by using RRC message with QoE-related commands (e.g., pause/resume QoE reporting, how to handle the QoE reports when UE is in either RRC_INACTIVE or RRC_IDLE, and so on.)

CN sends NGAP message to RAN node. The message may contain QoE priority information. At least one of the following information may be added into this message:
RAN node ID;

The available range (e.g., only for signaling based QoE, only for management based QoE, for both signaling based QoE and management based QoE).

### Pause/Resume QoE Reporting (Either Alternative May be Possible):

The QoE reporting will not be impacted if its QoE priority level is [higher/equal or higher] than X or the QoE session has the high priority indicator.

The QoE reporting will be impacted if its QoE priority level is [lower/equal or lower] than X or the QoE session has the low priority indicator.

### Buffered QoE Report (Either Alternative May be Possible):

QoE priority level sequence on how to arrange the buffered QoE reports overwrite rules.

QoE reports cannot be overwritten if its QoE priority level is [higher/equal or higher] than X or the QoE session has the higher priority indicator.

QoE reports can be overwritten if its QoE priority level is [lower/equal or lower] than X or the QoE session has the lower priority indicator.

QoE reports shall be kept for a longer time when UE is in either RRC_INACTIVE or RRC_IDLE state.

QoE reports can be kept at UE side longer if its QoE priority level is [higher/equal or higher] than X or the QoE session has the higher priority indicator or the QoE session does not have the lower priority indicator.

### QoE Reporting Priority:

QoE priority level sequence on how to arrange the buffered QoE reports reporting rules (e.g., QoE report with higher priority shall be reported to NW first).

QoE reporting may trigger the RRC state switching if this QoE session's priority is [higher/equal or higher] than X or the QoE session has the higher priority indicator.

QoE reporting cannot trigger the RRC state switching if this QoE session's priority is [lower/equal or lower] than X or the QoE session has the lower priority indicator.

### DC (Dual Connection) Leg Switching:

In DC case, UE connects two RAN nodes (e.g., Main Node and Secondary Node). For an ongoing QoE reporting between UE and one node (either MN or SN), if the QoE session's priority is [higher/equal or higher] than X or the QoE session has the higher priority indicator, the UE can stop the current QoE reporting via current node and continue to report the QoE data via the other node.

For an ongoing QoE reporting between UE and one node (either MN or SN), if the QoE session's priority is [lower/equal or lower] than X or the QoE session has the lower priority indicator, the UE cannot stop the current QoE reporting via current node and continue to report the QoE data via the other node.

The RRC procedure is optional, such that RAN node may not send the priority information to the UE.

When RAN node receives the QoE priority rule information, it will forward this information to the UE. At least one of the following information may be added into this message:
UE ID;
The available range (e.g., only for signaling based QoE, only for management based QoE, for both signaling based QoE and management based QoE).

### Pause/Resume QoE Reporting (Either Alternative May be Possible):

QoE reporting will not be impacted if its QoE priority level is [higher/equal or higher] than X or the QoE session has the high priority indicator.

QoE reporting will be impacted if its QoE priority level is [lower/equal or lower] than X or the QoE session has the low priority indicator.

### Buffered QoE Report (Either Alternative May be Possible.):

QoE priority level sequence on how to arrange the buffered QoE reports overwrite rules.

QoE reports cannot be overwritten if its QoE priority level is [higher/equal or higher] than X or the QoE session has the higher priority indicator.

QoE reports can be overwritten if its QoE priority level is [lower/equal or lower] than X or the QoE session has the lower priority indicator.

QoE reports shall be kept for a longer time when UE is in either RRC_INACTIVE or RRC_IDLE state.

QoE reports can be kept at UE side longer if its QoE priority level is [higher/equal or higher] than X or the QoE session has the higher priority indicator or the QoE session does not have the lower priority indicator.

### QoE Reporting Priority:

QoE priority level sequence on how to arrange the buffered QoE reports reporting rules. (e.g., QoE report with higher priority shall be reported to NW first)

QoE reporting may trigger the RRC state switching if this QoE session's priority is [higher/equal or higher] than X or the QoE session has the higher priority indicator.

QoE reporting cannot trigger the RRC state switching if this QoE session's priority is [lower/equal or lower] than X or the QoE session has the lower priority indicator.

### DC (Dual Connection) Leg Switching:

In DC case, UE connects two RAN nodes (e.g., Main Node and Secondary Node). For an ongoing QoE reporting between UE and one node (either MN or SN), if the QoE session's priority is [higher/equal or higher] than X or the QoE session has the higher priority indicator, the UE can stop the current QoE reporting via current node and continue to report the QoE data via the other node.

For an ongoing QoE reporting between UE and one node (either MN or SN), if the QoE session's priority is [lower/equal or lower] than X or the QoE session has the lower priority indicator, the UE cannot stop the current QoE reporting via current node and continue to report the QoE data via the other node.

### Potential Tabular for NGAP Procedure:

| | | | | |
|---|---|---|---|---|
| IE/Group | | | | |
| Name | Presence | Range | IE type and reference | Semantics description |

| | | | |
|---|---|---|---|
| UE ID | M | 9.3.1.1 | |
| Available | M | ENUMERATED (both, | Both means these rules |
| range of these | | s-based, m-based . . .) | work for both signaling |
| rules | | | based QoE and |
| | | | management based |
| | | | QoE. |
| | | | T-based means these |
| | | | rules work for signaling |
| | | | based QoE only. |
| | | | M-based means these |
| | | | rules work for |
| | | | management based QoE |
| | | | only. |
| Priority for | O | INTEGER (M . . . N, . . .), | The QoE reporting will |
| pause/resume | | or BIT STRING(M .. | not be impacted if its |
| QoE | | N . . .), or | QoE priority level is |
| reporting | | ENUMERATED (Low, | [higher/equal or higher] |
| | | Medium, High), or | than this value or the |
| | | ENUMERATED | QoE session has the |
| | | (true, . . .), or | priority indicator. OR |
| | | ENUMERATED (high | The QoE reporting will |
| | | priority, . . .), or | be impacted if its QoE |
| | | ENUMERATED | priority level is |
| | | (high, . . .) | [lower/equal or lower] |
| | | | than this value. |
| Priority for | O | INTEGER (M . . . N, . . .), | The QoE reports cannot |
| buffered QoE | | or BIT STRING(M .. | be overwritten if its |
| report | | N . . .), or | QoE priority level is |
| | | ENUMERATED (Low, | [higher/equal or higher] |
| | | Medium, High), or | than this value or the |
| | | ENUMERATED | QoE session has the |
| | | (true, . . .), or | priority indicator. |
| | | ENUMERATED (high | The QoE reports can be |
| | | priority, . . .), or | overwritten if its QoE |
| | | ENUMERATED | priority level is |
| | | (high, . . .) | [lower/equal or lower] |
| | | | than this value. |
| Priority for | O | INTEGER (M . . . N, . . .), | The QoE reports can be |
| buffered | | or BIT STRING (M . . . | kept at UE side longer if |
| duration | | N . . .), or | its QoE priority level is |
| | | ENUMERATED (Low, | [higher/equal or higher] |
| | | Medium, High), or | than this value or the |
| | | ENUMERATED | QoE session has the |
| | | (true, . . .), or | priority indicator. |
| | | ENUMERATED (high | |
| | | priority, . . .), or | |
| | | ENUMERATED | |
| | | (high, . . .) | |
| Priority for | O | INTEGER (M . . . N, . . .), | The QoE reports shall |
| QoE | | or BIT STRING(M .. | be reported prior if this |
| reporting | | N . . .), or | QoE priority is |
| | | ENUMERATED (Low, | [higher/equal or higher] |
| | | Medium, High), or | than this value or the |
| | | ENUMERATED | QoE session has the |
| | | (true, . . .), or | priority indicator. |
| | | ENUMERATED (high | |
| | | priority, . . .), or | |
| | | ENUMERATED | |
| | | (high, . . .) | |
| DC leg | O | INTEGER (M . . . N, . . .), | The QoE reporting leg |
| switching | | or BIT STRING (M . . . | can be switch to another |
| | | N . . .), or | node if the QoE |
| | | ENUMERATED (Low, | session's priority is |
| | | Medium, High), or | [higher/equal or higher] |
| | | ENUMERATED | than this value or the |
| | | (true, . . .), or | QoE session has the |
| | | ENUMERATED (high | priority indicator. |
| | | priority, . . .), or | |
| | | ENUMERATED | |
| | | (high, . . .) | |

### Embodiment 8

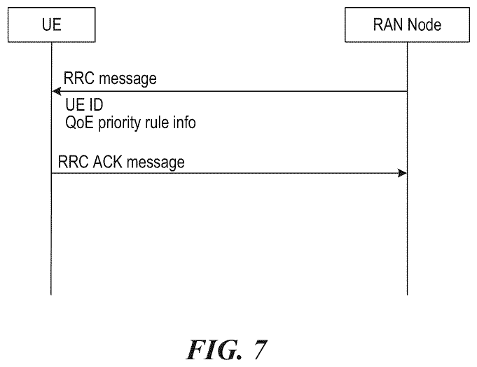

FIG. 7 shows an example of process of RAN node handles different QoE priority configurations.

In this embodiment, it is RAN node's responsibility for QoE priority configuration. RAN node may configure the QoE priority rule to UE with/without the QoE-related commands (e.g., pause/resume QoE reporting, how to handle the QoE reports when UE is in either RRC_INACTIVE or RRC_IDLE, and so on.). The priority rule information may be suited for both signaling based QoE and management based QoE or either signaling based QoE or management QoE.

RAN node may configure the QoE priority rule to a UE by using RRC message. At least one of the following information may be added into this message:
UE ID;

The available range (e.g., only for signaling based QoE, only for management based QoE, for both signaling based QoE and management based QoE).

### Pause/Resume QoE Reporting (Either Alternative May be Possible):

QoE reporting will not be impacted if its QoE priority level is [higher/equal or higher] than X or the QoE session has the high priority indicator.

QoE reporting will be impacted if its QoE priority level is [lower/equal or lower] than X or the QoE session has the low priority indicator.

### Buffered QoE Report (Either Alternative May be Possible):

QoE priority level sequence on how to arrange the buffered QoE reports overwrite rules.

QoE reports cannot be overwritten if its QoE priority level is [higher/equal or higher] than X or the QoE session has the higher priority indicator.

QoE reports can be overwritten if its QoE priority level is [lower/equal or lower] than X or the QoE session has the lower priority indicator.

QoE reports shall be kept for a longer time when UE is in either RRC_INACTIVE or RRC_IDLE state.

QoE reports can be kept at UE side longer if its QoE priority level is [higher/equal or higher] than X or the QoE session has the higher priority indicator or the QoE session does not have the lower priority indicator.

### QoE Reporting Priority:

QoE priority level sequence on how to arrange the buffered QoE reports reporting rules (e.g., QoE report with higher priority shall be reported to NW first).

QoE reporting may trigger the RRC state switching if this QoE session's priority is [higher/equal or higher] than X or the QoE session has the higher priority indicator.

QoE reporting cannot trigger the RRC state switching if this QoE session's priority is [lower/equal or lower] than X or the QoE session has the lower priority indicator.

### DC (Dual Connection) Leg Switching:

In DC case, UE connects two RAN nodes (e.g., Main Node and Secondary Node). For an ongoing QoE reporting between UE and one node (either MN or SN), if the QoE session's priority is [higher/equal or higher] than X or the QoE session has the higher priority indicator, the UE can stop the current QoE reporting via current node and continue to report the QoE data via the other node.

For an ongoing QoE reporting between UE and one node (either MN or SN), if the QoE session's priority is [lower/equal or lower] than X or the QoE session has the lower priority indicator, the UE cannot stop the current QoE reporting via current node and continue to report the QoE data via the other node.

### Embodiment 9

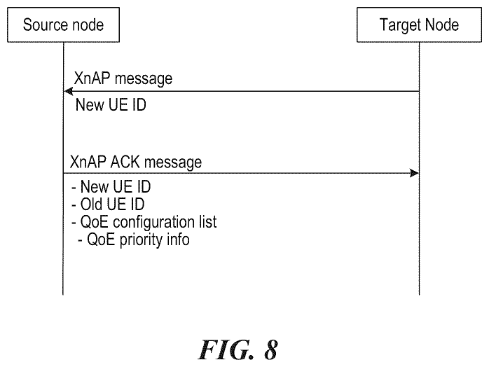

FIG. 8 shows an example of QoE priority retrieval from source RAN node based on inactive mobility.

When UE is trying to resume from RRC_INACTIVE to RRC_CONNECTED in a new RAN node, the new RAN node will trigger XnAP Retrieve UE Context procedure to retrieve UE context from source node. QoE priority information may also be retrieved from the source node.

Target node sends XnAP message (e.g., retrieve UE context request) to source node and try to retrieve the buffered UE context information from the source node. Source node replies the XnAP ACK message (e e.g., retrieve UE context response) to target node. At least one of the following information shall be contained in the reply message:
New UE ID (e.g. NG-RAN node UE XnAP ID, defined in 9.2.3.16, TS 38.423);
Old UE ID (e.g. NG-RAN node UE XnAP ID, defined in 9.2.3.16, TS 38.423);
Configured QoE priority information for each QoE configurations;
QoE ID (identification of a QoE configuration); and
QoE priority information (defined in the embodiment 1).

### Potential Tabular for the QoE Priority Information:

| | | | | |
|---|---|---|---|---|
| IE/Group | Pres- | | IE type and | |
| Name | ence | Range | reference | Semantics description |

| | | | |
|---|---|---|---|
| QoE ID | M | OCTET | This is the unique ID |
| | | STRING | for each QoE configuration |
| | | (SIZE(X)) | and is used to mark |
| | | | different QoE |
| | | | configurations. |

| | |
|---|---|
| QoE | # check the tabular in embodiment 1. |
| priority | |

### Embodiment 10

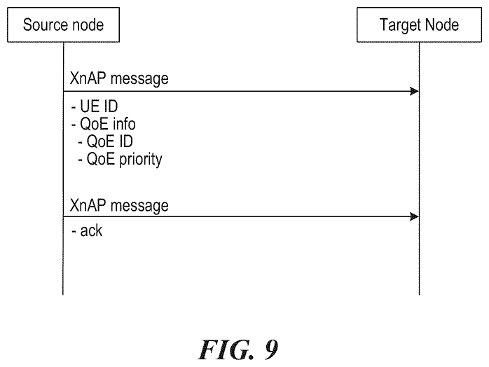

FIG. 9 shows an example of transferring QoE priority information during Xn based handover based on connected mobility and other common XnAP procedure.

This also works for other common XnAP procedures. It is not to be limited to handover procedure (e.g., MN forwards the QoE configuration and QoE priority information to SN).

This embodiment explains how QoE priority information transfer between source node and target node during Xn based handover. The following use cases are captured in this embodiment:
(intra-system intra-RAT) HO between gNBs;
(intra-system intra-RAT) HO between ng-eNBs;
(intra-system inter-RAT) HO from gNB to ng-eNB; and
(intra-system inter-RAT) HO from ng-eNB to gNB.

This embodiment also explains how QoE priority information transfer between two NG-RAN nodes (not handover).

The source node sends a XnAP message (e.g., Handover request message, S-Node Addition request, S-Node Modification Request, S-Node Modification Required, and other new XnAP procedures) to target node. At least one of the following contents shall be contained in this message:
UE ID (this is used to mark a UE)

For each QoE configuration with QoE priority information:

QoE ID (this is used to mark a QoE configuration. Different QoE configurations have different IDs).

QoE priority information (this is the QoE priority information for a QoE configuration/session with the QoE ID).

When target node receives the XnAP message, it will reply an XnAP ACK message (e.g., handover request ack) to source node.

### Embodiment 11

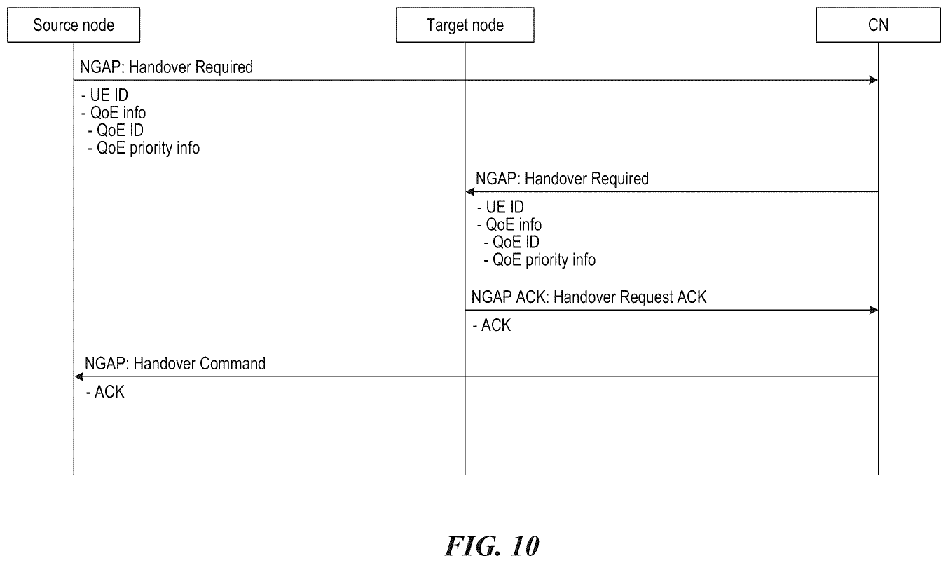

FIG. 10 shows an example of transferring QoE priority information during NG based handover based on connected mobility.

This embodiment explains how QoE priority information transferring between source node and target node during Xn based handover. The following use cases are captured in this embodiment:
(intra-system intra-RAT) HO between gNBs;
(intra-system intra-RAT) HO between ng-eNBs;
(intra-system inter-RAT) HO from gNB to ng-eNB; and
(intra-system inter-RAT) HO from ng-eNB to gNB.

Source node may trigger the NG based handover by sending the NGAP message (e.g., Handover required) to CN. And CN will send the NGAP message (e.g., Handover Request) to target node. At least one of the following contents shall be contained in these two messages:

UE ID(s) (this is used to mark a UE. In current handover required message, 2 IDs are used: AMF UE NGAP ID, RAN UE NGAP ID).

For each QoE configuration with QoE priority information:

QoE ID (this is used to mark a QoE configuration. Different QoE configurations have different IDs).

QoE priority information (this is the QoE priority information for a QoE configuration/session with the QoE ID).

When target node receives the information, it replies NGAP message (e.g., Handover Request ACK message) to CN. CN replies NGAP message (e.g., Handover Command).

Accordingly, some preferred embodiments may use the following solutions.

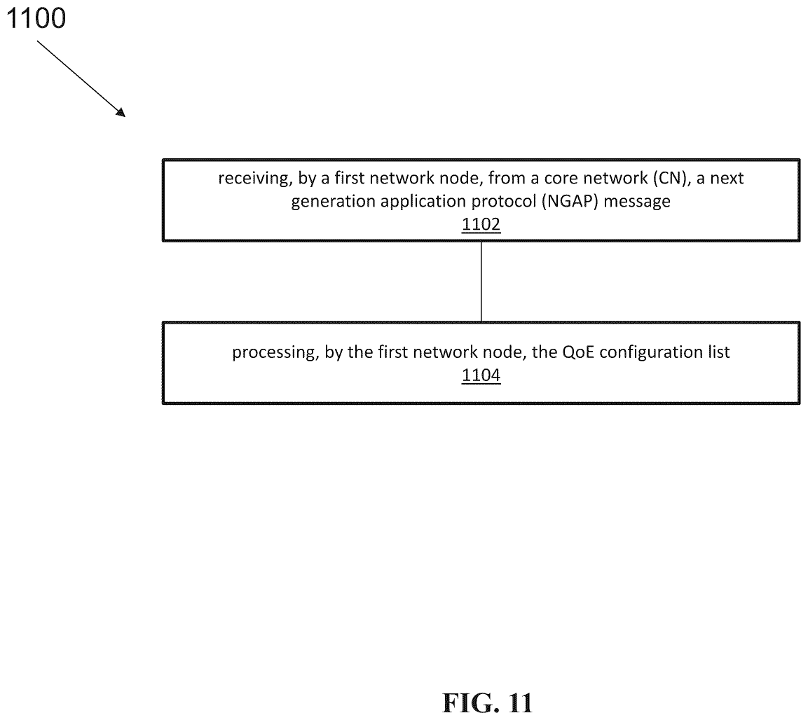

1. A method of wireless communication (e.g., method 1100 depicted in FIG. 11) including receiving, by a first network node, from a core network (CN), a next generation application protocol (NGAP) message (1102); wherein the NGAP message includes a quality of experience (QoE) configuration list; wherein the QoE configuration list includes a QoE identification (ID) and QoE priority information; wherein the CN predefines the QoE priority information; and processing, by the first network node, the QoE configuration list (1104). Additional details and examples are discussed with respect to Embodiment 2.

2. The method of solution 1 further comprising transmitting, after processing by the first network node, to the CN, QoE configuration list through the NGAP message.

3. The method of solution 1 further comprising transmitting, after processing by the first network node, to a wireless communication device, the QoE configuration list through a radio resource control (RRC) message.

4. The method of solution 3 further comprising configuring, by the wireless communication device, QoE configuration list based on QoE priority information.

5. The method of solution 4 further comprising receiving, by the first network node, after configuring by the wireless communication device, the QoE configuration list through a RRC message.

6. The method of solution 1 wherein the NGAP message further contains QoE configuration rules; wherein QoE configuration rules contains the first network node ID and QoE priority rules.

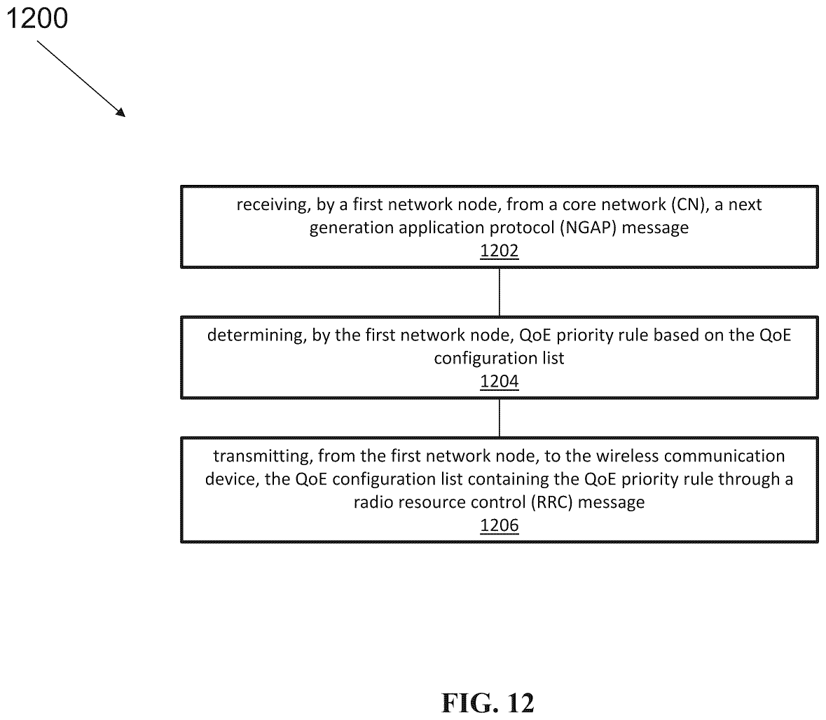

7. A method of wireless communication (e.g., method 1200 depicted in FIG. 12) including receiving, by a first network node, from a core network (CN), a next generation application protocol (NGAP) message (1202); wherein the NGAP message includes a quality of experience (QoE) configuration list; determining, by the first network node, QoE priority rule based on the QoE configuration list (1204); and transmitting, from the first network node, to the wireless communication device, the QoE configuration list containing the QoE priority rule through a radio resource control (RRC) message (1206). Additional details and examples are discussed with respect to Embodiment 4.

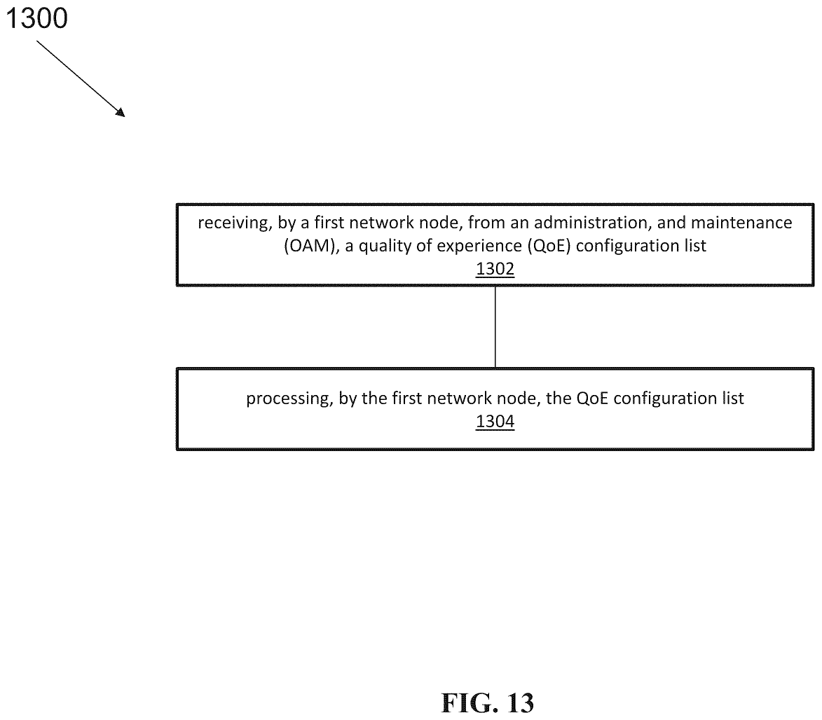

8. A method of wireless communication (e.g., method 1300 depicted in FIG. 13) including receiving, by a first network node, from an administration, and maintenance (OAM), a quality of experience (QoE) configuration list (1302); wherein the QoE configuration list contains QoE identification (ID) and QoE priority information; wherein the OAM predefines the QoE priority information; and processing, by the first network node, the QoE configuration list (1304). Additional details and examples are discussed with respect to Embodiment 2.

9. The method of solution 8 further comprising transmitting, after processing by the first network node, to the OAM, QoE configuration list.

10. The method of solution 8 further comprising transmitting, after processing by the first network node, to a wireless communication device, the QoE configuration list; wherein the QoE configuration list is transmitted through a radio resource control (RRC) message.

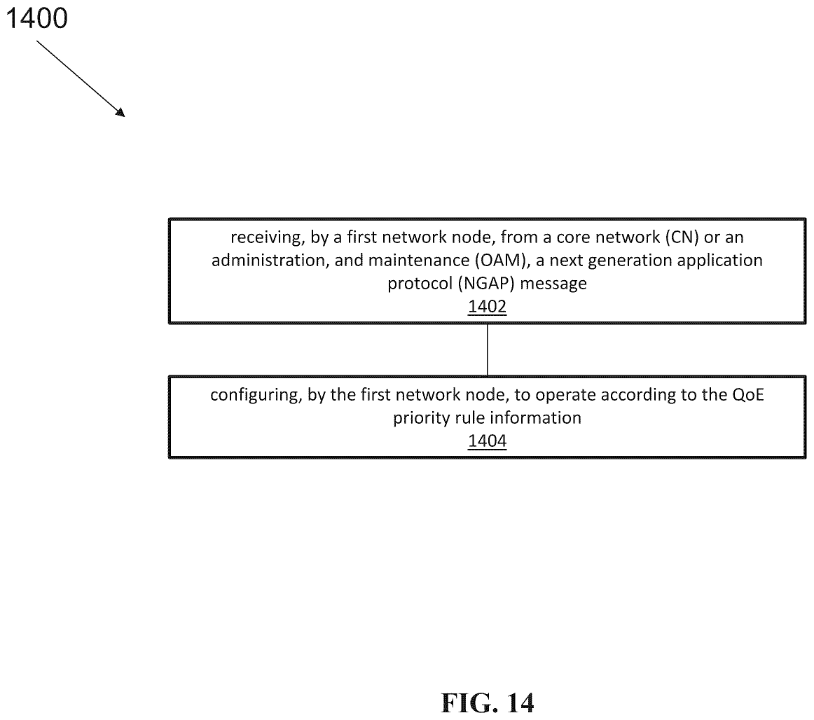

11. A method of wireless communication (e.g., method 1400 depicted in FIG. 14) including receiving, by a first network node, from a core network (CN) or an administration, and maintenance (OAM), a next generation application protocol (NGAP) message (1402); wherein the NGAP message contains user equipment (UE) identification (ID) and QoE priority rule information; wherein the QoE priority rule information contains at least one of the following: range availability, QoE reporting activity, buffered QoE reporting, QoE reporting duration, QoE reporting priority, or dual connection leg switching; and configuring, by the first network node, to operate according to the QoE priority rule information (1404). Additional details and examples are discussed with respect to Embodiments 6 and 7.

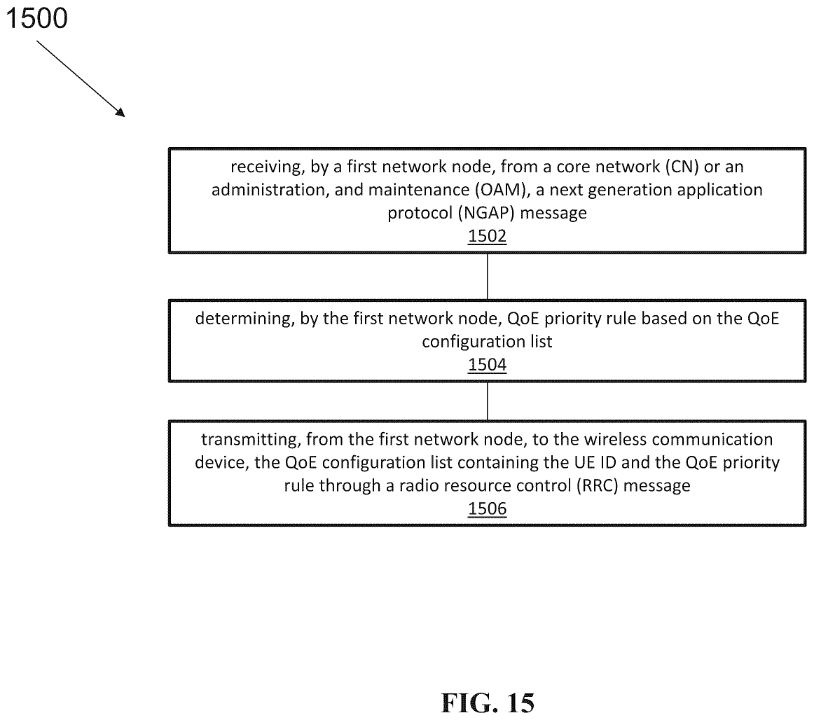

12. A method of wireless communication (e.g., method 1500 depicted in FIG. 15) including receiving, by a first network node, from a core network (CN) or an administration, and maintenance (OAM), a next generation application protocol (NGAP) message (1502); wherein the NGAP message includes contains user equipment (UE) identification (ID) and a quality of experience (QoE) configuration list; determining, by the first network node, QoE priority rule based on the QoE configuration list (1504); and transmitting, from the first network node, to the wireless communication device, the QoE configuration list containing the UE ID and the QoE priority rule through a radio resource control (RRC) message (1506). Additional details and examples are discussed with respect to Embodiment 8.

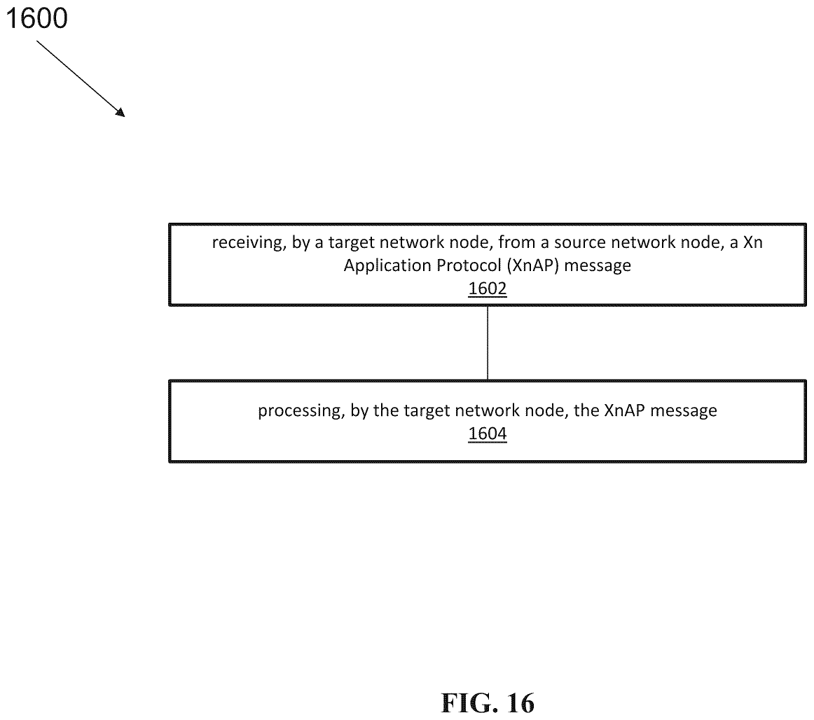

13. A method of wireless communication (e.g., method 1600 depicted in FIG. 16) including receiving, by a target network node, from a source network node, a Xn Application Protocol (XnAP) message (1602); wherein the XnAP message contains user equipment (UE) identification (ID) and quality of experience (QoE) information; wherein the QoE information further contains QoE ID and QoE priority information; and processing, by the target network node, the XnAP message (1604). Additional details and examples are discussed with respect to Embodiments 9 and 10.

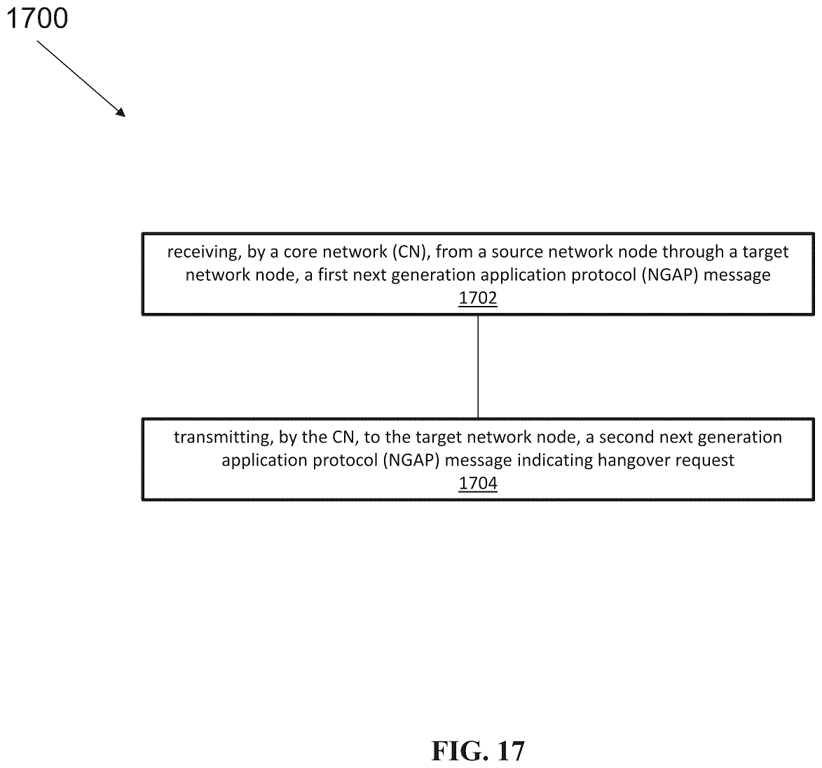

14. A method of wireless communication (e.g., method 1700 depicted in FIG. 17) including receiving, by a core network (CN), from a source network node through a target network node, a first next generation application protocol (NGAP) message (1702); wherein the first NGAP message is a handover message; wherein the first NGAP message contains user equipment (UE) identification (ID) and quality of experience (QoE) information; wherein the QoE information further contains QoE ID and QoE priority information; transmitting, by the CN, to the target network node, a second next generation application protocol (NGAP) message indicating hangover request (1704); wherein the second NGAP message contains the user equipment (UE) identification (ID) and quality of experience (QoE) information; and wherein the QoE information further contains QoE ID and QoE priority information. Additional details and examples are discussed with respect to Embodiment 11.

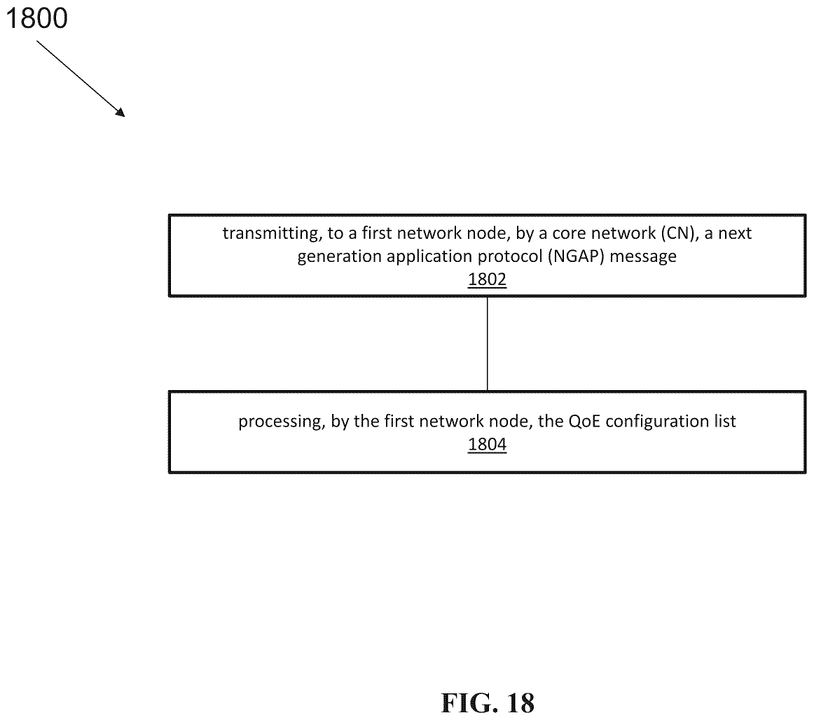

15. A method of wireless communication (e.g., method 1800 depicted in FIG. 18) including transmitting, to a first network node, by a core network (CN), a next generation application protocol (NGAP) message (1802); wherein the NGAP message includes a quality of experience (QoE) configuration list; wherein the QoE configuration list includes a QoE identification (ID) and QoE priority information; wherein the CN predefines the QoE priority information; and processing, by the first network node, the QoE configuration list (1804). Additional details and examples are discussed with respect to Embodiment 2.

16. The method of solution 15 further comprising: receiving, from the first network node after processing, by the CN, QoE configuration list through the NGAP message.

17. The method of solution 15 further comprising receiving, from the first network node after processing, by a wireless communication device, the QoE configuration list through a radio resource control (RRC) message.

18. The method of solution 17 further comprising configuring, by the wireless communication device, QoE configuration list based on QoE priority information.

19. The method of solution 18 further comprising transmitting, to the first network node, from the wireless after configuring communication device, the QoE configuration list through a RRC message.

20. The method of solution 15 wherein the NGAP message further contains QoE configuration rules; wherein QoE configuration rules contains the first network node ID and QoE priority rules.

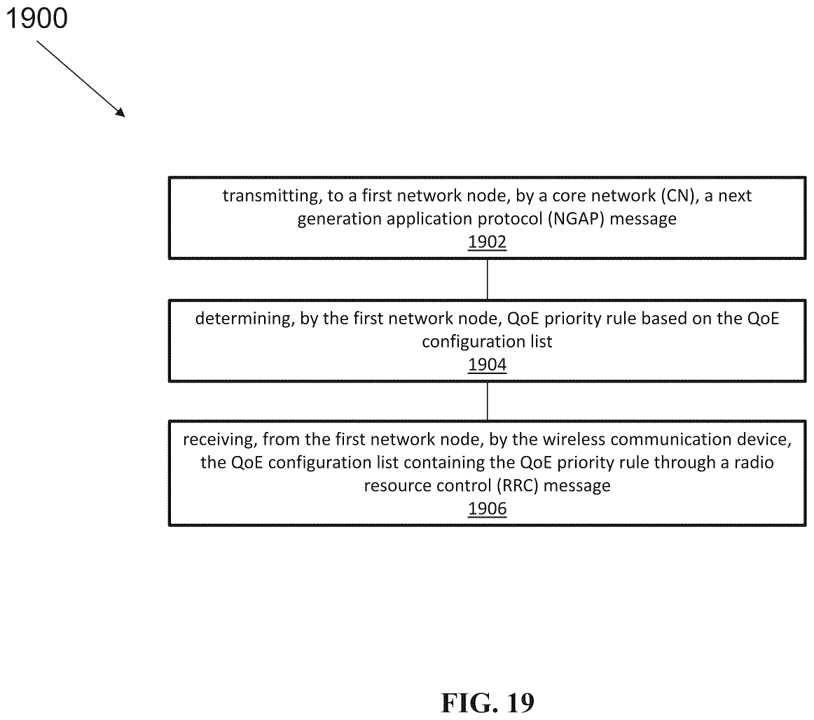

21. A method of wireless communication (e.g., method 1900 depicted in FIG. 19) including transmitting, to a first network node, by a core network (CN), a next generation application protocol (NGAP) message (1902); wherein the NGAP message includes a quality of experience (QoE) configuration list; determining, by the first network node, QoE priority rule based on the QoE configuration list (1904); and receiving, from the first network node, by the wireless communication device, the QoE configuration list containing the QoE priority rule through a radio resource control (RRC) message (1906). Additional details and examples are discussed with respect to Embodiment 4.

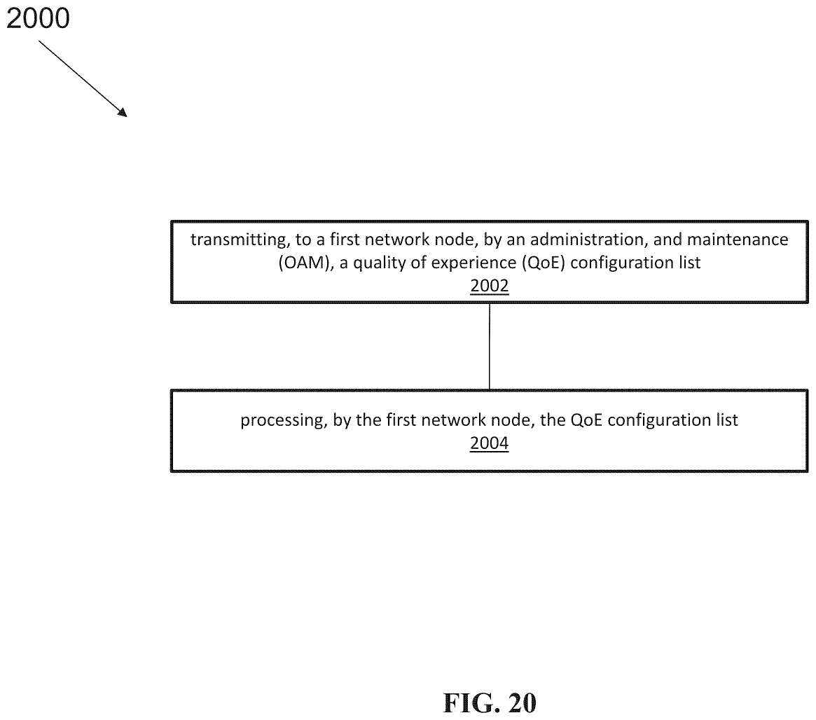

22. A method of wireless communication (e.g., method 2000 depicted in FIG. 20) including transmitting, to a first network node, by an administration, and maintenance (OAM), a quality of experience (QoE) configuration list (2002); wherein the QoE configuration list contains QoE identification (ID) and QoE priority information; wherein the OAM predefines the QoE priority information; and processing, by the first network node, the QoE configuration list (2004). Additional details and examples are discussed with respect to Embodiment 2.

23. The method of solution 22 further comprising receiving, from the first network node after processing, by the OAM, QoE configuration list.

24. The method of solution 22 further comprising receiving, from the first network node after processing, by a wireless communication device, the QoE configuration list; wherein the QoE configuration list is transmitted through a radio resource control (RRC) message.

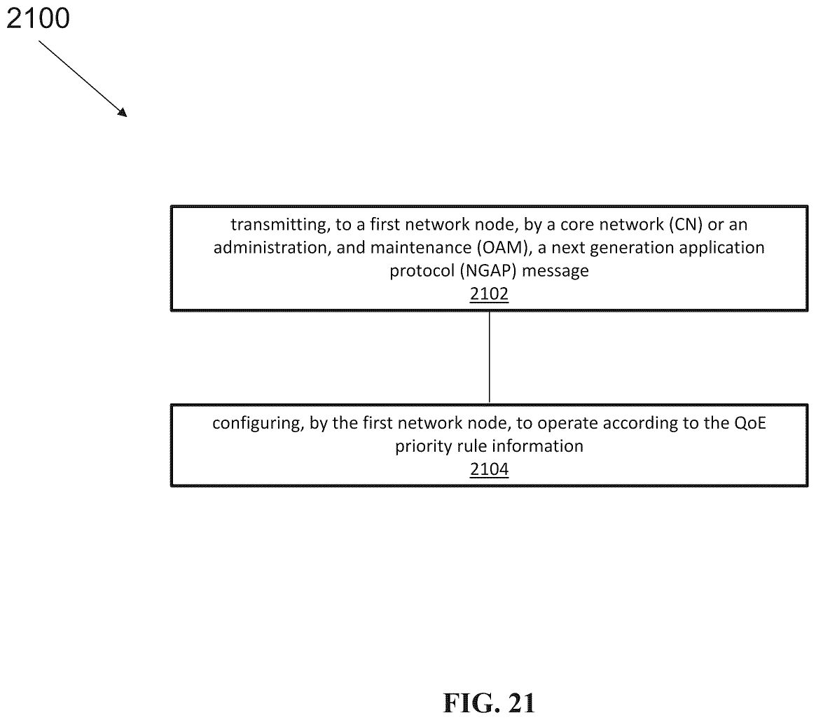

25. A method of wireless communication (e.g., method 2100 depicted in FIG. 21) including transmitting, to a first network node, by a core network (CN) or an administration, and maintenance (OAM), a next generation application protocol (NGAP) message (2102); wherein the NGAP message contains user equipment (UE) identification (ID) and QoE priority rule information; wherein the QoE priority rule information contains at least one of the following: range availability, QoE reporting activity, buffered QoE reporting, QoE reporting duration, QoE reporting priority, or dual connection leg switching; and configuring, by the first network node, to operate according to the QoE priority rule information (2104). Additional details and examples are discussed with respect to Embodiments 6 and 7.

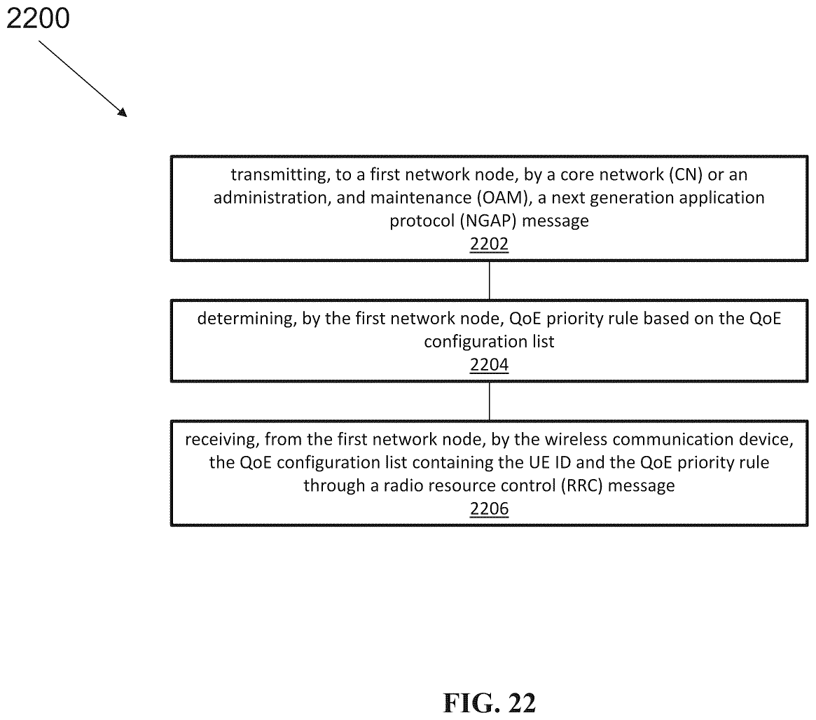

26. A method of wireless communication (e.g., method 2200 depicted in FIG. 22) including transmitting, to a first network node, by a core network (CN) or an administration, and maintenance (OAM), a next generation application protocol (NGAP) message (2202); wherein the NGAP message includes contains user equipment (UE) identification (ID) and a quality of experience (QoE) configuration list; determining, by the first network node, QoE priority rule based on the QoE configuration list (2204); and receiving, from the first network node, by the wireless communication device, the QoE configuration list containing the UE ID and the QoE priority rule through a radio resource control (RRC) message (2206). Additional details and examples are discussed with respect to Embodiment 8.

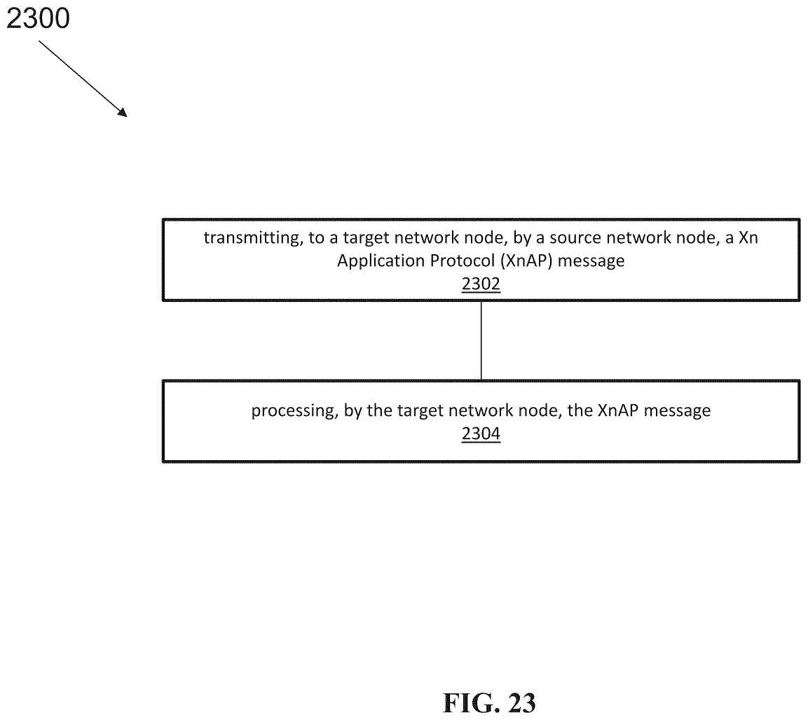

27. A method of wireless communication (e.g., method 2300 depicted in FIG. 23) including transmitting, to a target network node, by a source network node, a Xn Application Protocol (XnAP) message (2302); wherein the XnAP message contains user equipment (UE) identification (ID) and quality of experience (QoE) information; wherein the QoE information further contains QoE ID and QoE priority information; and processing, by the target network node, the XnAP message (2304). Additional details and examples are discussed with respect to Embodiments 9 and 10.

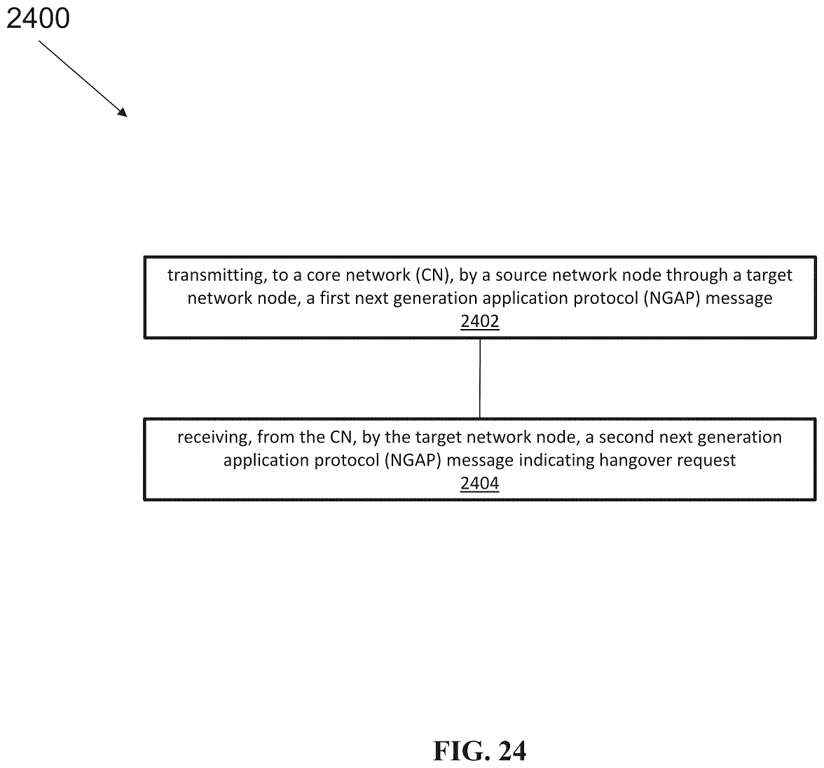

28. A method of wireless communication (e.g., method 2400 depicted in FIG. 24) including transmitting, to a core network (CN), by a source network node through a target network node, a first next generation application protocol (NGAP) message (2402); wherein the first NGAP message is a handover message; wherein the first NGAP message contains user equipment (UE) identification (ID) and quality of experience (QoE) information; wherein the QoE information further contains QoE ID and QoE priority information; receiving, from the CN, by the target network node, a second next generation application protocol (NGAP) message indicating hangover request (2404); wherein the second NGAP message contains the user equipment (UE) identification (ID) and quality of experience (QoE) information; and wherein the QoE information further contains QoE ID and QoE priority information. Additional details and examples are discussed with respect to Embodiment 11.

29. The method of any of solution 1-28, wherein QoE priority is identified by at least one of the following: priority level, priority rank, or a one bit indicator; wherein priority level is defined by a numerical value; wherein priority rank is defined by low, medium, or high; and wherein the bit indicator is defined by true or false.

30. A communication apparatus comprising a processor configured to implement a method recited in any one or more of solution 1 to 29.

31. A computer readable medium having code stored thereon, the code, when executed, causing a processor to implement a method recited in any one or more of solution 1 to 29.

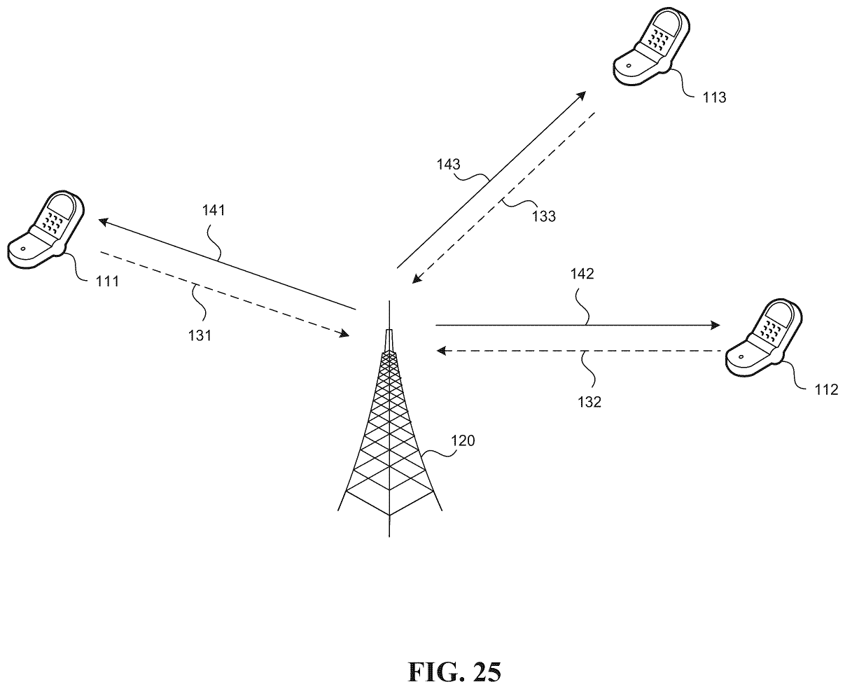

FIG. 25 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

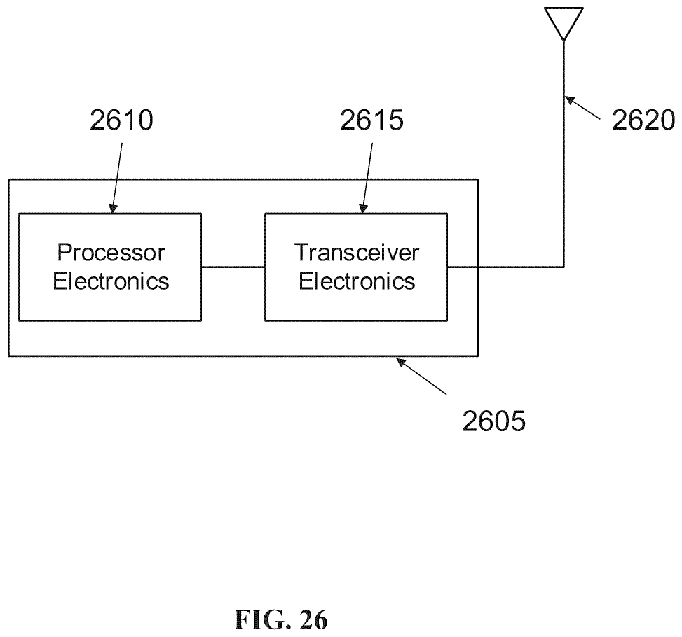

FIG. 26 is a block diagram representation of a portion of an apparatus, in accordance with some embodiments of the presently disclosed technology. An apparatus 2605 such as a network device or a base station or a wireless device (or UE), can include processor electronics 2610 such as a microprocessor that implements one or more of the techniques presented in this document. The apparatus 2605 can include transceiver electronics 2615 to send and/or receive wireless signals over one or more communication interfaces such as antenna(s) 2620. The apparatus 2605 can include other communication interfaces for transmitting and receiving data. Apparatus 2605 can include one or more memories (not explicitly shown) configured to store information such as data and/or instructions. In some implementations, the processor electronics 2610 can include at least a portion of the transceiver electronics 2615. In some embodiments, at least some of the disclosed techniques, modules or functions are implemented using the apparatus 2605.

It is intended that the specification, together with the drawings, be considered exemplary only, where exemplary means an example and, unless otherwise stated, does not imply an ideal or a preferred embodiment. As used herein, the use of “or” is intended to include “and/or”, unless the context clearly indicates otherwise.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

1. A method of wireless communication, comprising:
receiving, by a first network node, from a core network (CN), a next generation application protocol (NGAP) message;
wherein the NGAP message includes a quality of experience (QoE) configuration list;
wherein the QoE configuration list includes a QoE identification (ID) and QoE priority information; and
processing, by the first network node, the QoE configuration list.

2. (canceled)

3. The method of claim 1 further comprising:
transmitting, after processing by the first network node, to a wireless communication device, the QoE configuration list through a radio resource control (RRC) message.

4-12. (canceled)

13. A method of wireless communication, comprising:
receiving, by a target network node, from a source network node, a Xn Application Protocol (XnAP) message;
wherein the XnAP message contains user equipment (UE) identification (ID) and quality of experience (QoE) information;
wherein the QoE information further contains QoE ID and QoE priority information; and
processing, by the target network node, the XnAP message.

14. A method of wireless communication, comprising:
receiving, by a core network (CN), from a source network node through a target network node, a first next generation application protocol (NGAP) message;
wherein the first NGAP message is a handover message;
wherein the first NGAP message contains user equipment (UE) identification (ID) and quality of experience (QoE) information;
wherein the QoE information further contains QoE ID and QoE priority information;
transmitting, by the CN, to the target network node, a second next generation application protocol (NGAP) message indicating handover request;
wherein the second NGAP message contains the user equipment (UE) identification (ID) and quality of experience (QoE) information; and
wherein the QoE information further contains QoE ID and QoE priority information.

15-28. (canceled)

29. The method of claim 1, wherein a QoE priority is identified by a priority level,
wherein the priority level is defined by a numerical value.

30-31. (canceled)

32. The method of claim 13, wherein a QoE priority is identified by a priority level, Wherein the priority level is defined by a numerical value.

33. The method of claim 14, wherein a QoE priority is identified by a priority level, wherein the priority level is defined by a numerical value.
